(19) United States
(12) Patent Application Publication
(10) Pub. No.: US 2018/0232325 A1
(43) Pub. Date: Aug. 16, 2018

(54) MEMORY SYSTEM AND METHOD FOR OPERATING THE SAME

(71) Applicant: SK hynix Inc., Gyeonggi-do (KR)

(72) Inventors: Young-Guen CHOI, Gyeonggi-do (KR); Soong-Sun SHIN, Gyeonggi-do (KR)

(21) Appl. No.: 15/794,085

(22) Filed: Oct. 26, 2017

(30) Foreign Application Priority Data
Feb. 16, 2017 (KR) 10-2017-0021227

(51) Int. Cl. G06F 13/16; G06F 3/06; G06F 12/02

(52) U.S. Cl. CPC G06F 13/1626; G06F 3/0659; G06F 12/0246; G06F 3/061; G06F 3/0679

(57) ABSTRACT

A memory system includes: a memory device for including a plurality of memory blocks each of which includes a plurality of pages, a plurality of planes each of which includes the memory blocks, and a plurality of memory dies each of which includes the planes; and a controller for grouping a plurality of read commands that are transferred from a host into one or more read command groups based on a policy that is designed in such a manner that a read operation is performed in an order from a relatively big physical area unit to a relatively small physical area unit based on a physical address value of each of the read commands, when the read commands are transferred from the host, and applying each of the read command groups to a read operation of the memory device.

### CROSS-REFERENCE TO RELATED APPLICATIONS

The present application claims priority of Korean Patent Application No. 10-2017-0021227, filed on Feb. 16, 2017, which is incorporated herein by reference in its entirety.

### BACKGROUND

### 1. Field

Exemplary embodiments of the present invention relate to a memory system, and more particularly, to a memory system capable of re-ordering commands and a method for operating the memory system.

### 2. Description of the Related Art

The computer environment paradigm has changed to ubiquitous computing systems that can be used anytime and anywhere. Due to this fact, use of portable electronic devices such as mobile phones, digital cameras, and notebook computers has rapidly increased. These portable electronic devices generally use a memory system having one or more memory devices for storing data. A memory system may be used as a main memory device or an auxiliary memory device of a portable electronic device.

Memory systems provide excellent stability, durability, high information access speed, and low power consumption since they have no moving parts. Examples of memory systems having such advantages include universal serial bus (USB) memory devices, memory cards having various interfaces, and solid state drives (SSD).

### SUMMARY

Embodiments of the present invention are directed to a memory system capable of re-ordering commands and a method for operating the memory system.

In accordance with an embodiment of the present invention, a memory system may include: a memory device including a plurality of memory dies; and a controller suitable for grouping a plurality of read commands into one or more read command groups according to the memory dies as target memory dies of the read commands, arranging in the respective read command groups the read commands according to sizes of read area of the read commands in the respective target memory dies, and controlling the memory device to perform read operations in response to the grouped and arranged read commands, the controller may arrange the read commands based on physical addresses of the target memory die identified from the read commands, and starting points of the read operations to the memory device in response to the read commands may be predetermined.

The controller may arrange the read commands included in the respective read command groups in descending order of the sizes of read area of the read commands.

The controller may further arrange the read commands included in the respective read command groups in an input order of the read commands, which have the same size of read area as one another, and the input order of the read commands may be an order of the read commands input to the memory system.

The controller may group the read commands such that read commands directed to the same target memory die as one another are included in one of the read command groups.

The controller may further arrange the read command groups according to an input order of the read commands, which respectively have greatest sizes of read area in the respective read command groups, and the input order of the read commands may be an order of the read commands input to the memory system.

When a write command is provided amongst the read commands to the memory system, the controller may further split a read command group, which is directed to the same target memory die as the write command among the read command groups, into two sub read command groups, between the split two sub read command groups, a first sub read command group may include one or more read commands, which are provided to the memory system prior to the write command, and between the split two sub read command groups, a second sub read command group may include one or more read commands, which are provided to the memory system after the write command.

The memory system may further include a mapping table storing mapping relation between a logical address and a physical address of the memory dies, and the controller may further identify the physical addresses of the target memory die from logical addresses provided with the read commands through the mapping table.

In accordance with another embodiment of the present invention, a method for operating a memory system including a memory device having a plurality of memory dies, the method include: grouping a plurality of read commands into one or more read command groups according to the memory dies as target memory dies of the read commands; arranging in the respective read command groups the read commands according to sizes of read area of the read commands in the respective target memory dies; and controlling the memory device to perform read operations in response to the grouped and arranged read commands, the read commands may be arranged on a basis of physical addresses of the target memory die identified from the read commands, and starting points of the read operations to the memory device in response to the read commands may be predetermined.

The read commands may be arranged in the respective read command groups in descending order of the sizes of read area of the read commands.

The method may further include arranging the read commands included in the respective read command groups in an input order of the read commands, which have the same size of read area as one another, and the input order of the read commands may be an order of the read commands input to the memory system.

The grouping of the read commands may be performed such that read commands directed to the same target memory die as one another are included in one of the read command groups.

The method of may further include arranging the read command groups according to an input order of the read commands, which respectively have greatest sizes of read area in the respective read command groups,

The input order of the read commands may be an order of the read commands input to the memory system.

The method may further include, when a write command is provided amongst the read commands to the memory system, splitting a read command group, which is directed to the same target memory die as the write command among the read command groups, into two sub read command groups, between the split two sub read command groups, a first sub read command group may include one or more read commands, which are provided to the memory system prior to the write command, and between the split two sub read command groups, a second sub read command group may include one or more read commands, which are provided to the memory system after the write command.

The method may further include identifying the physical addresses of the target memory die from logical addresses provided with the read commands through a mapping table storing mapping relation between a logical address and a physical address of the memory dies.

### BRIEF DESCRIPTION OF THE DRAWINGS

These and other features and advantages of the present invention will become apparent to those skilled in the art to which the present invention pertains from the following detailed description in reference to the accompanying drawings, wherein:

FIG. 1 is a block diagram illustrating a data processing system including a memory system in accordance with an embodiment of the present invention;

FIG. 2 is a schematic diagram illustrating an exemplary configuration of a memory device employed in the memory system shown in FIG. 1;

FIG. 3 is a circuit diagram illustrating an exemplary configuration of a memory cell array of a memory block in the memory device shown in FIG. 2;

FIG. 4 is a schematic diagram illustrating an exemplary three-dimensional structure of the memory device shown in FIG. 2; and

FIG. 5 is a block diagram illustrating an example of a characteristic operation of the memory system shown in FIG. 1;

FIG. 6 is a block diagram illustrating an example of the characteristic operation of the memory system shown in FIG. 1;

FIG. 7 is a block diagram illustrating an example of the characteristic operation of the memory system shown in FIG. 1;

FIG. 8 is a block diagram illustrating a memory system, in accordance with another embodiment of the present invention; and

FIGS. 9 to 17 are diagrams schematically illustrating application examples of the data processing system shown in FIG. 1, in accordance with various embodiments of the present invention.

### DETAILED DESCRIPTION

Various embodiments of the present invention are described below in more detail with reference to the accompanying drawings. We note, however, that the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not Intended to be limiting of the present invention. As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

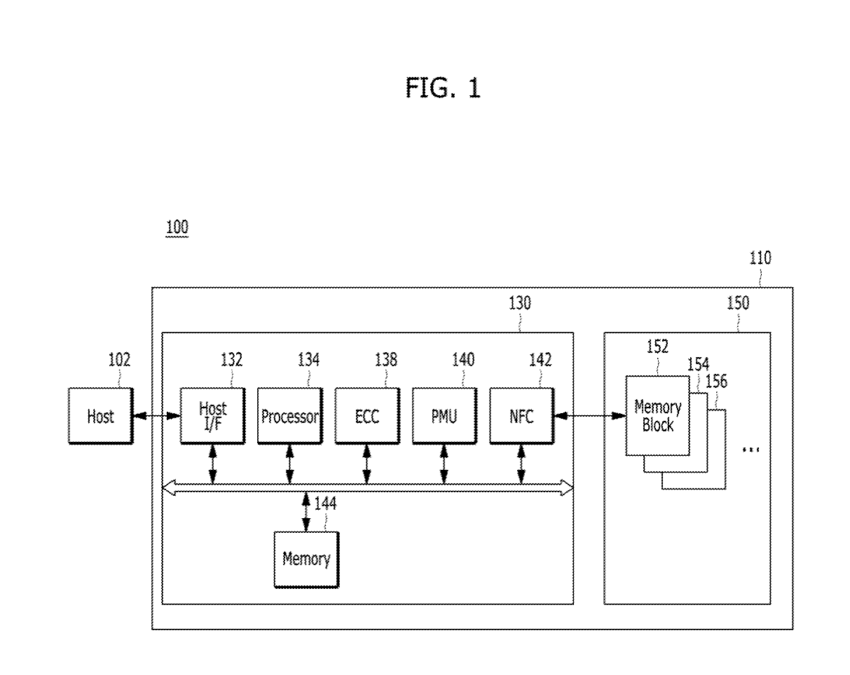

FIG. 1 is a block diagram illustrating a data processing system 100 including a memory system 110 in accordance with an embodiment of the present invention.

Referring to FIG. 1, the data processing system 100 may include a host 102 operatively coupled to the memory system 110.

The host 102 may include portable electronic devices such as a mobile phone, MP3 player and laptop computer or non-portable electronic devices such as a desktop computer, game machine, TV and projector.

The memory system 110 may operate to store data for the host 102 in response to a request of the host 102. Non-limited examples of the memory system 110 may include a solid state drive (SSD), a multi-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC, and the SD card may include a mini-SD card and micro-SD card.

The memory system 110 may be embodied by various types of storage devices. Non-limited examples of storage devices included in the memory system 110 may include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), resistive RAM (RRAM) and a flash memory. The flash memory may have a 3-dimensional (3D) stack structure.

The memory system 110 may include a memory device 150 and a controller 130. The memory device 150 may store data for the host 120, and the controller 130 may control data storage into the memory device 150.

The controller 130 and the memory device 150 may be integrated into a single semiconductor device, which may be included in the various types of memory systems as exemplified above.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

The memory device 150 may be a nonvolatile memory device and may retain data stored therein even though power is not supplied. The memory device 150 may store data provided from the host 102 through a write operation, and provide data stored therein to the host 102 through a read operation. The memory device 150 may include a plurality of memory dies, each memory die including a plurality of planes, each plane including a plurality of memory blocks 152 to 156, each of the memory blocks 152 to 156 may include a plurality of pages, and each of the pages may include a plurality of memory cells coupled to a word line.

The controller 130 may control the memory device 150 in response to a request from the host 102. For example, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) unit 132, a processor 134, an error correction code (ECC) unit 138, a Power Management Unit (PMU) 140, a NAND flash controller (NFC) 142 and a memory 144 all operatively coupled via an internal bus.

The host interface unit 132 may be configured to process a command and data of the host 102, and may communicate with the host 102 through one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE).

The ECC unit 138 may detect and correct an error contained in the data read from the memory device 150. In other words, the ECC unit 138 may perform an error correction decoding process to the data read from the memory device 150 through an ECC code used during an ECC encoding process. According to a result of the error correction decoding process, the ECC unit 138 may output a signal, for example, an error correction success/fail signal. When the number of error bits is more than a threshold value of correctable error bits, the ECC unit 138 may not correct the error bits, and may output an error correction fail signal.

The ECC unit 138 may perform error correction through a coded modulation such as Low Density Parity Check (LDPC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC unit 138 is not limited thereto. The ECC unit 138 may include all circuits, modules, systems or devices for error correction.

The PMU 140 may provide and manage power of the controller 130.

The NFC 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the NFC 142 may generate a control signal for the memory device 150 and process data to be provided to the memory device 150 under the control of the processor 134. The NFC 142 may work as an interface (e.g., a NAND flash interface) for processing a command and data between the controller 130 and the memory device 150. Specifically, the NFC 142 may support data transfer between the controller 130 and the memory device 150.

The memory 144 may serve as a working memory of the memory system 110 and the controller 130, and store data for driving the memory system 110 and the controller 130. The controller 130 may control the memory device 150 to perform read, write, program and erase operations in response to a request from the host 102. The controller 130 may provide data read from the memory device 150 to the host 102, may store data provided from the host 102 into the memory device 150. The memory 144 may store data required for the controller 130 and the memory device 150 to perform these operations.

The memory 144 may be embodied by a volatile memory. For example, the memory 144 may be embodied by static random access memory (SRAM) or dynamic random access memory (DRAM). The memory 144 may be disposed within or out of the controller 130. FIG. 1 exemplifies the memory 144 disposed within the controller 130. In an embodiment, the memory 144 may be embodied by an external volatile memory having a memory interface transferring data between the memory 144 and the controller 130.

The processor 134 may control the overall operations of the memory system 110. The processor 134 may drive firmware to control the overall operations of the memory system 110. The firmware may be referred to as flash translation layer (FTL).

The processor 134 of the controller 130 may include a management unit (not illustrated) for performing a bad management operation of the memory device 150. The management unit may perform a bad block management operation of checking a bad block, in which a program fail occurs due to the characteristic of a NAND flash memory during a program operation, among the plurality of memory blocks 152 to 156 included in the memory device 150. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation needs to be performed with more reliability.

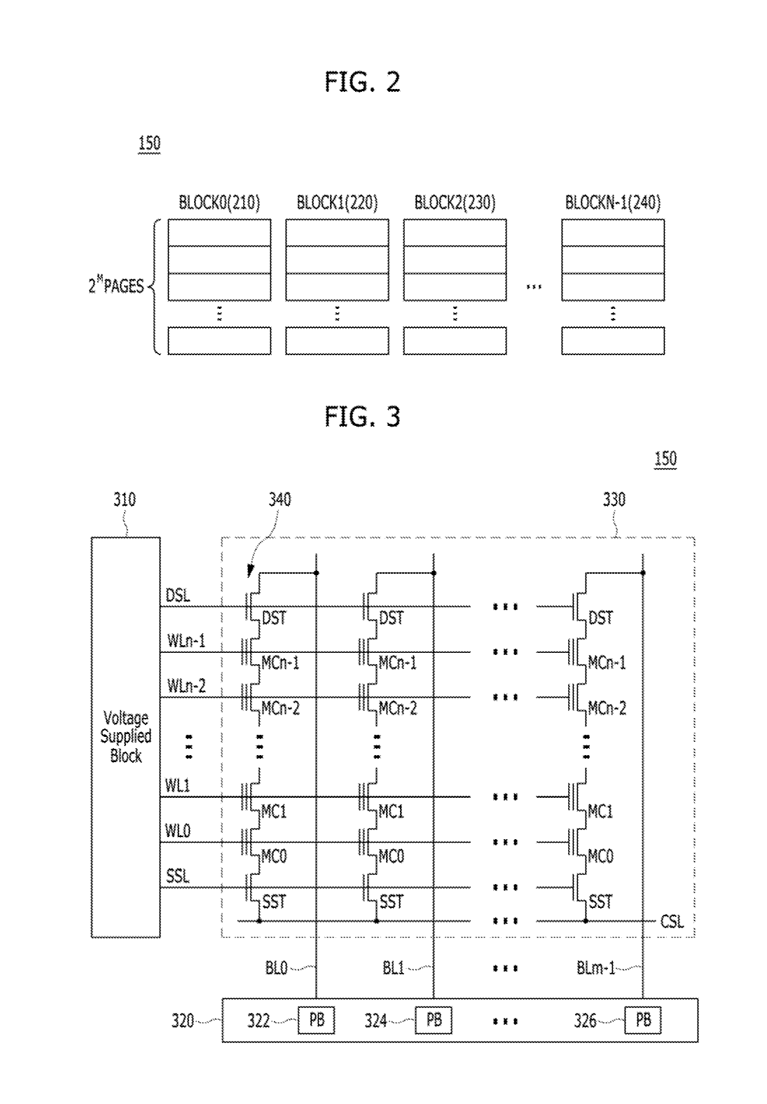

FIG. 2 is a schematic diagram illustrating the memory device 150.

Referring to FIG. 2, the memory device 150 may include a plurality of memory blocks 0 to N−1, and each of the blocks 0 to N−1 may include a plurality of pages, for example, 2^{M} pages, the number of which may vary according to circuit design. Memory cells included in the respective memory blocks 0 to N−1 may be one or more of a single level cell (SLC) storing 1-bit data, a multi-level cell (MLC) storing 2-bit data, a triple level cell (TLC) storing 3-bit data, a quadruple level cell (QLC) storing 4-bit level cell, a multiple level cell storing 5-or-more-bit data, and so forth.

FIG. 3 is a circuit diagram Illustrating an exemplary configuration of a memory cell array of a memory block in the memory device 150.

Referring to FIG. 3, a memory block 330 which may correspond to any of the plurality of memory blocks 152 to 156 included in the memory device 150 of the memory system 110 may include a plurality of cell strings 340 coupled to a plurality of corresponding bit lines BL0 to BLm−1. The cell string 340 of each column may include one or more drain select transistors DST and one or more source select transistors SST. Between the drain and source select transistors DST and SST, a plurality of memory cells MC0 to MCn−1 may be coupled in series. In an embodiment, each of the memory cell transistors MC0 to MCn−1 may be embodied by an MLC capable of storing data information of a plurality of bits. Each of the cell strings 340 may be electrically coupled to a corresponding bit line among the plurality of bit lines BL0 to BLm−1. For example, as illustrated in FIG. 3, the first cell string is coupled to the first bit line BL0, and the last cell string is coupled to the last bit line BLm−1.

Although FIG. 3 illustrates NAND flash memory cells, the invention is not limited in this way. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage and a pass voltage to supply to the word lines according to an operation mode. The voltage generation operation of the voltage supply unit 310 may be controlled by a control circuit (not Illustrated). Under the control of the control circuit, the voltage supply unit 310 may select one of the memory blocks (or sectors) of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and drive bit lines according to the received data. The read/write circuit 320 may include a plurality of page buffers 322 to 326 respectively corresponding to columns (or bit lines) or column pairs (or bit line pairs), and each of the page buffers 322 to 326 may include a plurality of latches (not illustrated).

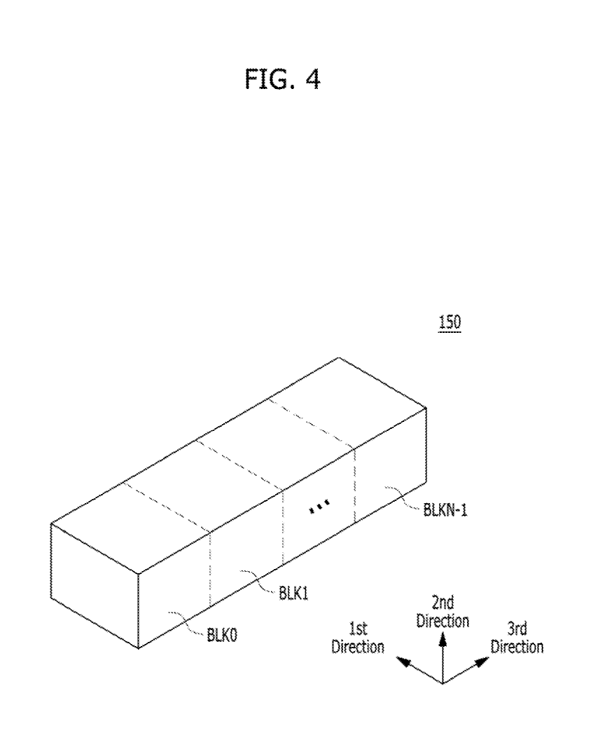

FIG. 4 is a schematic diagram illustrating an exemplary 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN−1 each having a 3D structure (or vertical structure).

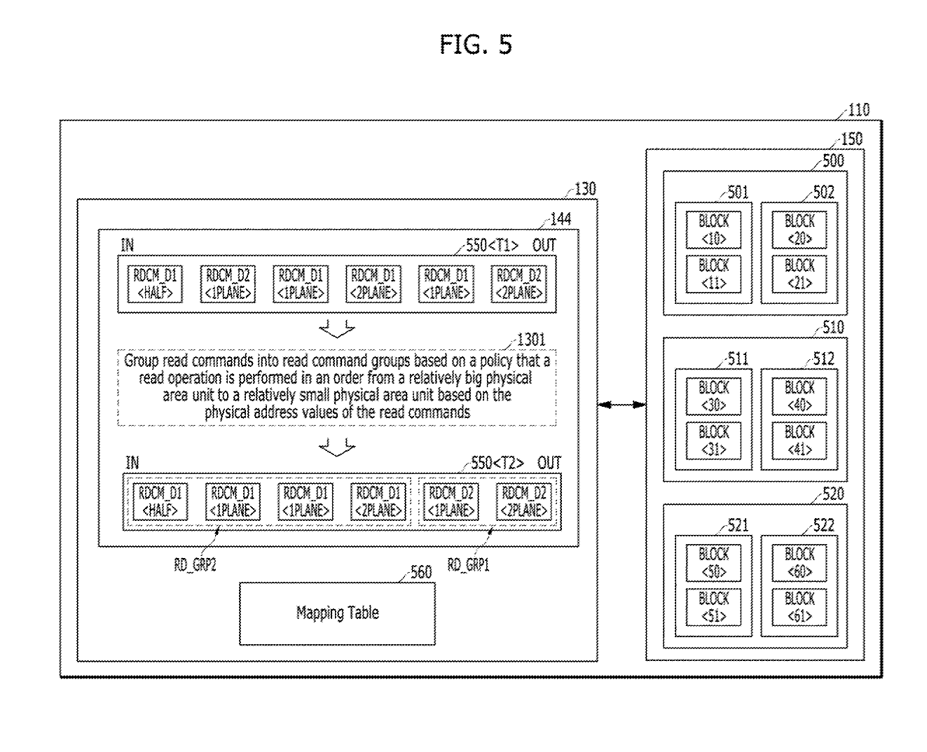

FIGS. 5 to 7 are block diagrams illustrating a characteristic operation of the memory system shown in FIG. 1

Referring to FIGS. 5 to 7, as an example, the memory device 150 may include a plurality of memory dies 500, 510 and 520, and each of the memory dies 500, 510 and 520 may include a plurality of planes 501 and 502, 511 and 512, and 521 and 522, respectively. Each of the planes 501 and 502, 511 and 512, and 521 and 522 may include a plurality of memory blocks BLOCK<10, 11>, BLOCK<20, 21>, BLOCK<30, 31>, BLOCK<40, 41>, BLOCK<50, 51>, and BLOCK<60, 61>. Each of the memory blocks BLOCK<10, 11>, BLOCK<20, 21>, BLOCK<30, 31>, BLOCK<40, 41>, BLOCK<50, 51>, and BLOCK<60, 61> may include a plurality of pages.

Referring to FIG. 5, when the host 102 provides a plurality of read commands RDCM_D2<2PLANE>, RDCM_D1<1PLANE>, RDCM_D1<2PLANE>, RDCM_D1<1PLANE>, RDCM_D2<1PLANE> and RDCM_D1<HALF>, the controller 130 may group the provided read commands into one or more read command groups RD_GRP1 and RD_GRP2 with respect to memory dies of the memory device 150. Further, in each of the read command groups RD_GRP1 and RD_GRP2, the controller 130 may order the read commands according to the size of the read area of the memory device 150 for the respective read command such that read operations are sequentially performed in response to the provided, grouped and ordered read commands in each of the read command groups RD_GRP1 and RD_GRP2. The sizes of the read areas for the respective read commands may be designated by the read commands through logical addresses provided with the read commands, and may be identified from the physical addresses of the provided read commands.

For example, as illustrated in FIG. 5, six read commands may be transferred to the memory system 110 at a moment T1. The transferred six read commands may be stored in a command queue 520<T1> in the inside of the controller 130 in an order of input to the memory system 110.

Herein, each of the six read commands RDCM_D2<2PLANE>, RDCM_D1<1PLANE>, RDCM_D1<2PLANE>, RDCM_D1<1PLANE>, RDCM_D2<1PLANE> and RDCM_D1<HALF> may include a first information D1, D2 or D3 that represents to which memory die the corresponding read command belongs among three memory dies 500, 510 and 520 of the memory device 150. Also, each of the six read commands may include a second information, for example, 2PLANE, 1PLANE and HALF which may represent a multi-page, a single page and a part of a single page in the read-target memory die, respectively.

Herein, the first information and the second information may be identified from the physical address of the corresponding read command and the physical address may be identified from a mapping table 560 based on the logical address provided with the read commands.

According to an embodiment of the present invention, a starting point of the read operation in the respective memory blocks of the memory device 150 may be predetermined. The starting point of the read operation may be a particular page of a particular memory block in a particular memory plane. For example, the starting point of the read operation may be a first page of a first memory block in a first memory plane.

For example, the starting point of the read operation for a first read command RDCM_D2<2PLANE> may be a first page of the respective first and second memory blocks BLOCK<30> and BLOCK<40> in two planes 511 and 512, which are corresponding to “<2PLANE>” of the first read command RDCM_D2<2PLANE>, included in the second memory die 510, which is corresponding to “D2” of the first read command RDCM_D2<2PLANE>. For example, the starting point of the read operation for a fifth read command RDCM_D2<1PLANE> may be a first page of the first memory block BLOCK<30> in the first plane 511 between two planes 511 and 512, which is corresponding to “<1PLANE>” of the fifth read command RDCM_D2<1PLANE>, included in the second memory die 510, which is corresponding to “D2” of the fifth read command RDCM_D2<1PLANE>. For example, the starting point of the read operation for a sixth read command RDCM_D1<HALF> may be a first page, which is corresponding to “<HALF>” of the sixth read command RDCM_D1<HALF>, included in the first memory block BLOCK<10> of the first plane 501 in the first memory die 500, which is corresponding to “D1” of the sixth read command RDCM_D1<HALF>. Data of a first half in the first page may be read in response to the sixth read command RDCM_D1<HALF>.

The controller 130 may classify the provided read commands into several groups according to priorities of the provided read command. The priority of a read command may depend on the second information, i.e., the size of the read area “<size of read area>” of the read command. For example, a priority of a read command RDCM_DN<2PLANE> may be highest, a priority of a read command RDCM_DN<1PLANE> may be Intermediate, and a priority of a read command RDCM_DN<HALF> may be lowest.

Therefore, referring to the command queue 520<T1> of FIG. 5, the first and third read commands RDCM_D2<2PLANE> and RDCM_D1<2PLANE> may be classified into a first priority group having the highest priority, the second, fourth and fifth read commands RDCM_D1<1PLANE>, RDCM_D1<1PLANE> and RDCM_D2<1PLANE> may be classified into a second priority group having the intermediate priority, and the sixth read command RDCM_D1<HALF> may be classified into a third priority group having the lowest priority.

The controller 130 may generate one or more read command groups RD_GRP1 and RD_GRP2 for the respective target memory dies or the second and first memory dies 510 and 500 such that the read commands of the highest priority (e.g., the first and third read commands RDCM_D2<2PLANE> and RDCM_D1<2PLANE> of the first priority) are included in the read command groups RD_GRP1 and RD_GRP2, respectively. When there are a plurality of read commands having the same target memory die, the read commands having the same target memory die may be included in the same one among the read command groups RD_GRP1 and RD_GRP2. The operation order of the read command groups RD_GRP1 and RD_GRP2 may depend on the input order of corresponding read commands of the first priority.

The controller 130 may include the read commands of the second and third priorities in the respective read command groups RD_GRP1 and RD_GRP2 according to the target memory dies of the read commands such that read commands of the same target memory die are included in the same one among the read command groups RD_GRP1 and RD_GRP2.

In the respective read command groups RD_GRP1 and RD_GRP2, the order of the read commands may depend on the priorities and input order of the read commands. A read command of a higher priority and earlier input order may be served first in the respective read command groups RD_GRP1 and RD_GRP2.

Therefore, at a moment T2, the controller 130 may generate the read command groups RD_GRP1 and RD_GRP2 including the first and third read commands RDCM_D2<2PLANE> and RDCM_D1<2PLANE> for the target memory dies or the second and first memory dies 510 and 500, respectively. Further, the controller 130 may include in the read command group RD_GRP1 the fifth read command RDCM_D2<1PLANE> of the second priority and having the same target memory dies (i.e., the second memory die 510) as the first read command RDCM_D2<2PLANE> of the first priority and also included in the read command group RD_GRP1. Still further, the controller 130 may include in the read command group RD_GRP2 the second, fourth and sixth read commands RDCM_D1<1PLANE>, RDCM_D1<1PLANE> and RDCM_D1<HALF> of the second and third priorities for the same target memory dies (i.e., the first memory die 500) as the third read command RDCM_D1<2PLANE> of the first priority and also included in the read command group RD_GRP2.

FIG. 5 exemplifies that at a moment T2 following moment T1, the first and fifth read commands RDCM_D2<2PLANE> and RDCM_D2<1PLANE> that are included in the first read command group RD_GRP1 are stored ahead of the third, second, fourth and sixth read commands RDCM_D1<2PLANE>, RDCM_D1<1PLANE>, RDCM_D1<1PLANE>, and RDCM_D1<HALF> that are Included in the second read command group RD_GRP2, in the command queue 550<T2>.

To sum up, the controller 130 may basically perform read operations not according to the input order of the read commands but according to a new order determined based on the sizes of the read areas of the read commands.

In response to the first read command RDCM_D2<2PLANE> of the first read command group RD_GRP1, two pages may be read at once by reading data from the first page of each of the first memory blocks BLOCK<30> and BLOCK<40> in the two planes 511 and 512 that are included in the second memory die 510. Herein, the data of the two pages that are read at once may be kept in two page buffers respectively corresponding to the two planes 511 and 512 that are included in the second memory die 510.

In response to the second read command RDCM_D2<1PLANE> of the first read command group RD_GRP1, data may be read from the page buffer corresponding to the first plane 511 of the second memory die 510 since the size of read area for the first read command RDCM_D2<2PLANE> of the first read command group RD_GRP1 is greater than the size of read area for the second read command RDCM_D2<1PLANE> and thus the data read from the first memory block BLOCK<30> of the first plane 511 in response to the first read command RDCM_D2<2PLANE> of the first read command group RD_GRP1 is still kept in the page buffer corresponding to the first plane 511 of the second memory die 510.

In response to the first read command RDCM_D1<2PLANE> of the second read command group RD_GRP2, the data of two pages may be read at once by reading the data from the first page of each of the first memory blocks BLOCK<10> and BLOCK<20> in the two planes 501 and 502 that are included in the first memory die 500. Herein, the two-page data that are read at once may be kept in two page buffers respectively corresponding to the two planes 501 and 502 that are included in the first memory die 500.

In response to the second read command RDCM_D1<1PLANE> of the second read command group RD_GRP2, data may be read from the page buffer corresponding to the first plane 501 of the first memory die 500 since the size of read area for the first read command RDCM_D1<2PLANE> of the second read command group RD_GRP2 is greater than the size of read area for the second read command RDCM_D1<1PLANE> and thus the data read from the first memory block BLOCK<10> of the first plane 501 in response to the first read command RDCM_D1<2PLANE> of the second read command group RD_GRP2 is still kept in the page buffer corresponding to the first plane 501 of the first memory die 500.

In similar way, data may be read from the page buffer corresponding to the first plane 501 of the first memory die 500 in response to each of the third and fourth read commands RDCM_D1<1PLANE> and RDCM_D1<HALF> of the second read command group RD_GRP2.

As described above, when read operations are performed to the memory device 150 in response to the ordered read commands in the command queue 550<T2> at the moment T2, an additional read operation may be prevented.

Therefore, a number of read operation times actually performed to the memory device 150 may be reduced or minimized.

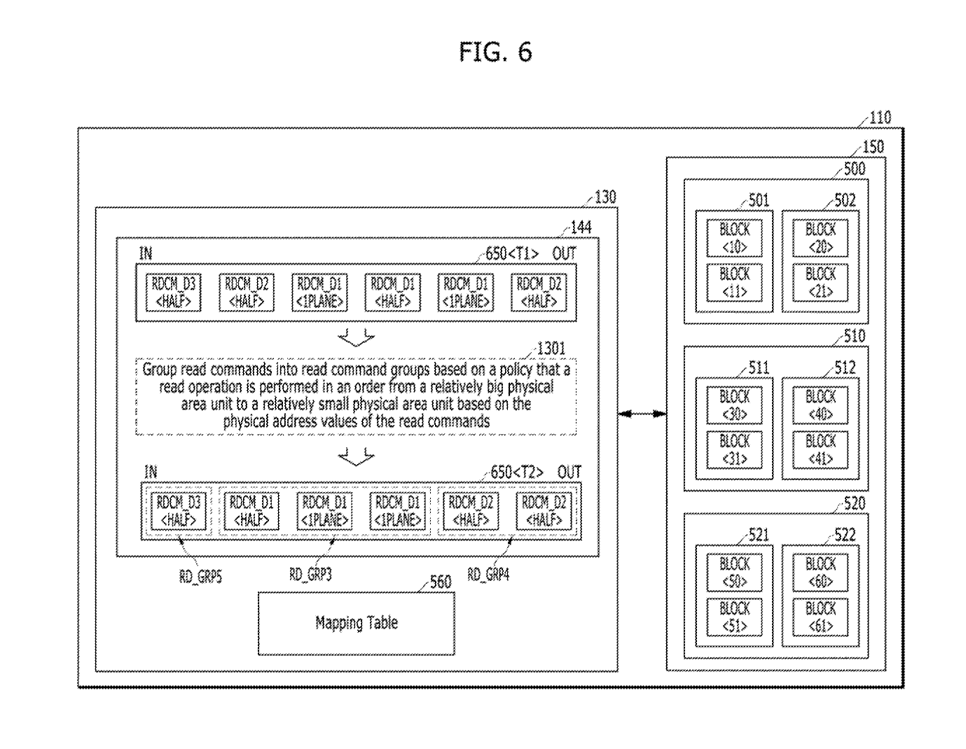

FIG. 6 shows another exemplary case of read commands RDCM_D2<HALF>, RDCM_D1<1PLANE>, RDCM_D1<HALF>, RDCM_D1<1PLANE>, RDCM_D2<HALF>, and RDCM_D3<HALF> sequentially provided to the memory system 110 from the host 102 and queued in a command queue 650<T1> in an order of input in the inside of the controller 130 at a moment T1.

Referring to FIG. 6, the controller 130 may classify a second read command RDCM_D1<1PLANE> into the second priority group, and first and third to sixth read commands RDCM_D2<HALF>, RDCM_D1<HALF>, RDCM_D1<1PLANE>, RDCM_D2<HALF>, and RDCM_D3<HALF> into the third priority group. FIG. 6 exemplifies no read command of the first priority, and no read command of the second priority for the second memory die 510.

Referring to FIG. 6, the controller 130 may generate one or more read command groups RD_GRP3 and RD_GRP4 for the respective target memory dies or the second and first memory dies 510 and 500 such that the read commands of the highest priority (e.g., the first and second read commands RDCM_D2<HALF> and RDCM_D1<1PLANE> of the third and second priorities, respectively) are included in the read command groups RD_GRP3 and RD_GRP4, respectively.

Referring to FIG. 6, the controller 130 may include the read commands of the second and third priorities in the respective read command groups RD_GRP3 and RD_GRP4 according to the target memory dies of the read commands such that read commands of the same target memory die are included in the same one among the read command groups RD_GRP3 and RD_GRP4.

Referring to FIG. 6, at a moment T2, the controller 130 may generate the read command groups RD_GRP3 to RD_GRP5 including the read commands of the highest priority, e.g., the first, second and sixth read commands RDCM_D2<HALF>, RDCM_D1<1PLANE> and RDCM_D3<HALF> of the second and third priorities, for the target memory dies or the first to third memory dies 500, 510 and 520, respectively.

Further, the controller 130 may include in the read command group RD_GRP3 the fifth read command RDCM_D2<HALF> of the third priority and having the same target memory dies (i.e., the second memory die 510) as the first read command RDCM_D2<HALF> of the highest or third priority and also included in the read command group RD_GRP3.

Still further, the controller 130 may include in the read command group RD_GRP4 the fourth and third read commands RDCM_D1<1PLANE> and RDCM_D1<HALF> of the second and third priorities and having the same target memory dies (i.e., the first memory die 500) as the second read command RDCM_D1<1PLANE> of the highest or second priority and also included in the read command group RD_GRP4.

The controller 130 may not include in the read command group RD_GRP5 any read command since there is no read command having the same target memory die (i.e., the third memory die 520) as the sixth read command RDCM_D3<HALF>.

FIG. 6 exemplifies, at a moment T2 which comes later than the moment T1, that the read commands in the third read command group RD_GRP3 are stored ahead of the read commands in the fourth read command group RD_GRP4 and the read commands in the fourth read command group RD_GRP4 are stored ahead of the read command in the fifth read command group RD_GRP5, in the command queue 550<T2>, which is similar to the example described with reference to FIG. 5.

Therefore, in a similar way to the embodiment described with reference to FIG. 5, when read operations are performed to the memory device 150 in response to the ordered read commands in the command queue 550<T2> at the moment T2, an additional read operation may be prevented.

Therefore, the number of read operation times actually performed to the memory device 150 may be reduced or minimized.

Specifically, referring to FIG. 6, the controller 130 may group read commands RDCM_D2<HALF>, RDCM_D1<1PLANE>, RDCM_D1<HALF>, RDCM_D1<1PLANE>, RDCM_D2<HALF>, and RDCM_D3<HALF> into at least one read command group RD_GRP3 or RD_GRP4 according to a policy that is designed in such a manner that a read operation may be performed in the memory device 150 from relatively big physical area units to relatively small physical area units based on the physical address value of each of the read commands RDCM_D2<HALF>, RDCM_D1<1PLANE>, RDCM_D1<HALF>, RDCM_D1<1PLANE>, RDCM_D2<HALF>, and RDCM_D3<HALF> in 1301, and apply each read command group RD_GRP3 or RD_GRP4 to a read operation in the memory device 150.

First of all, at a moment T1, the read commands RDCM_D2<HALF>, RDCM_D1<1PLANE>, RDCM_D1<HALF>, RDCM_D1<1PLANE>, RDCM_D2<HALF>, and RDCM_D3<HALF> may be transferred from the host 102 to the memory system 110.

For example, as illustrated in the drawing, six read commands RDCM_D2<HALF>, RDCM_D1<1PLANE>, RDCM_D1<HALF>, RDCM_D1<1PLANE>, RDCM_D2<HALF>, and RDCM_D3<HALF> may be transferred to the memory system 110 at the moment T1. The six read commands RDCM_D2<HALF>, RDCM_D1<1PLANE>, RDCM_D1<HALF>, RDCM_D1<1PLANE>, RDCM_D2<HALF>, and RDCM_D3<HALF> transferred to the memory system 110 at the moment T1 may be stored in a command queue 620<T1> in the inside of the controller 130 in the order that the six read commands are inputted to the memory system 110.

Herein, it is possible to detect a first information D1, D2 or D3 and a second information ‘2PLANE’, ‘1PLANE’, or ‘HALF’ from the physical address number of each of the six read commands RDCM_D2<HALF>, RDCM_D1<1PLANE>, RDCM_D1<HALF>, RDCM_D1<1PLANE>.

To be specific, it may be seen from FIG. 6 that the read command RDCM_D2<HALF> that is inputted for the first time among the six read commands RDCM_D2<HALF>, RDCM_D1<1PLANE>, RDCM_D1<HALF>, RDCM_D1<1PLANE>, RDCM_D2<HALF>, and RDCM_D3<HALF> may be a read command corresponding to a half page in one plane 511 or 512 that are included in the second memory die 510. Also, the read command RDCM_D1<1PLANE> that is inputted for the second time may be a read command corresponding to one plane 501 or 502 that is included in the first memory die 500. Also, the read command RDCM_D1<HALF> that is inputted for the third time may be a read command corresponding to a half page in one plane 501 or 502 that is included in the first memory die 500. Also, the read command RDCM_D1<1PLANE> that is inputted for the fourth time may be a read command corresponding to one plane 501 or 502 that is included in the first memory die 500. Also, the read command RDCM_D2<HALF> that is inputted for the fifth time may be a read command corresponding to a half page in one plane 511 or 512 that is included in the second memory die 510. Also, the read command RDCM_D3<HALF> that is inputted for the sixth time may be a read command corresponding to a half page in one plane 521 or 522 that is included in the third memory die 520.

The controller 130 may decide a read command for a multi-page corresponding to a memory die unit as a first read command whose priority is highest based on the result of checking out the physical address value of each of the read commands RDCM_D2<HALF>, RDCM_D1<1PLANE>, RDCM_D1<HALF>, RDCM_D1<1PLANE>, RDCM_D2<HALF>, and RDCM_D3<HALF>, decide a read command for a unit page corresponding to a plane unit as a second read command whose priority is lower than that of the first read command, and decide a read command for a divided page, which is smaller than the plane unit, as a third read command whose priority is lower than that of the second read command.

Herein, there is no read command that may be decided as the first read command and there are only read commands that may be decided as the second read commands and the third read commands in the six read commands RDCM_D2<HALF>, RDCM_D1<1PLANE>, RDCM_D1<HALF>, RDCM_D1<1PLANE>, RDCM_D2<HALF>, and RDCM_D3<HALF> in the example of FIG. 6.

For example, the controller 130 may decide the read commands corresponding to one plane, which are the read command RDCM_D1<1PLANE> that is inputted for the second time and the read command RDCM_D1<1PLANE> that is inputted for the fourth time, among the six read commands RDCM_D2<HALF>, RDCM_D<1PLANE>, RDCM_D1<HALF>, RDCM_D1<1PLANE>, RDCM_D2<HALF>, and RDCM_D3<HALF> as the second read commands. Also, the controller 130 may decide the read commands corresponding to a half page which is smaller than one plane, which are the read command RDCM_D2<HALF> that is inputted for the first time, the read command RDCM_D1<HALF> that is inputted for the third time, and the read command RDCM_D3<HALF> that is inputted for the sixth time, among the six read commands RDCM_D2<HALF>, RDCM_D1<1PLANE>, RDCM_D1<HALF>, RDCM_D1<1PLANE>, RDCM_D2<HALF>, and RDCM_D3<HALF> as the third read commands.

As described above, the controller 130 may divide the read commands RDCM_D2<HALF>, RDCM_D1<1PLANE>, RDCM_D1<HALF>, RDCM_D1<1PLANE>, RDCM_D2<HALF>, and RDCM_D3<HALF> into the first to third read commands based on the result of checking out the physical address values of the read commands RDCM_D2<HALF>, RDCM_D1<1PLANE>, RDCM_D1<HALF>, RDCM_D1<1PLANE>, RDCM_D2<HALF>, and RDCM_D3<HALF>, and group the read commands RDCM_D2<HALF>, RDCM_D1<1PLANE>, RDCM_D1<HALF>, RDCM_D1<1PLANE>, RDCM_D2<HALF>, and RDCM_D3<HALF> into at least one or more read command groups RD_GRP1 and/or RD_GRP2 based on a policy that is designed in such a manner that a read operation may be performed in the memory device 150 in an order from a relatively big physical area unit to a relatively small physical area unit based on the first to third read commands in 1301.

To be specific, as Illustrated in FIG. 6, the controller 130 may perform an operation of grouping the read commands RDCM_D2<HALF>, RDCM_D1<1PLANE>, RDCM_D1<HALF>, RDCM_D1<1PLANE>, RDCM_D2<HALF>, and RDCM_D3<HALF> based on the policy as follows.

First of all, the controller 130 may check out to which memory die among the memory dies 500, 510 and 520 the read commands that are decided as the second read commands among the read commands RDCM_D2<HALF>, RDCM_D1<1PLANE>, RDCM_D1<HALF>, RDCM_D1<1PLANE>, RDCM_D2<HALF>, and RDCM_D3<HALF> correspond, because there is no read command that is decided as the first read command.

Herein, the read commands RDCM_D2<HALF>, RDCM_D1<1PLANE>, RDCM_D1<HALF>, RDCM_D1<1PLANE>, RDCM_D2<HALF>, and RDCM_D3<HALF> are checked out in the order that the read commands RDCM_D2<HALF>, RDCM_D1<1PLANE>, RDCM_D1<HALF>, RDCM_D1<1PLANE>, RDCM_D2<HALF>, and RDCM_D3<HALF> are inputted to the command queue 650<T1> until the moment T1. Therefore, the controller 130 may decide the read command RDCM_D1<1PLANE> that is inputted for the second time as the second read command among the six read commands RDCM_D2<HALF>, RDCM_D1<1PLANE>, RDCM_D1<HALF>, RDCM_D1<1PLANE>, RDCM_D2<HALF>, and RDCM_D3<HALF> that are stored in the command queue 650<T1> at the moment T1 and, at the same time, the controller 130 may find out that the read command RDCM_D1<1PLANE> that is inputted for the second time corresponds to the first memory die 500 among the memory dies 500, 510 and 520.

Subsequently, the controller 130 may check out whether there is another second read command that corresponds to the memory die, e.g., the first memory die 500, to which the read command RDCM_D2<2PLANE> that is inputted for the second time and decided as the second read command in the first corresponds among the six read commands RDCM_D2<HALF>, RDCM_D1<1PLANE>, RDCM_D1<HALF>, RDCM_D1<1PLANE>, RDCM_D2<HALF>, and RDCM_D3<HALF> that are stored in the command queue 650<T1> at the moment T1, and whether there are the third read commands that correspond to the planes 501 and 502 included in the first memory die 500. If there are such read commands, the controller 130 may group the read commands as the third read command group RD_GRP3.

Therefore, the controller 130 may group the read command RDCM_D1<HALF> that is inputted for the third time and the read command RDCM_D1<1PLANE> that is inputted for the fourth time that correspond to the planes 501 and 502 included in the first memory die 500 among the six read commands RDCM_D2<HALF>, RDCM_D1<1PLANE>, RDCM_D1<HALF>, RDCM_D1<1PLANE>, RDCM_D2<HALF>, and RDCM_D3<HALF> as the third read command group RD_GRP3 along with the read command RDCM_D1<1PLANE> that is inputted for the second time.

Also, when the controller 130 forms the third read command group RD_GRP3, the controller 130 may adjust the order of the command queue 650 in such a manner that the read command RDCM_D1<1PLANE> that is inputted for the second time and decided as the second read command is applied to a read operation of the memory device 150 prior to the read command RDCM_D1<HALF> that is inputted for the third time and decided as the third read command. Also, when the controller 130 forms the third read command group RD_GRP3, the controller 130 may adjust the order of the command queue 650 in such a manner that the two read commands that are decided as the second read commands, which are the read command RDCM_D1<1PLANE> that is inputted for the second time and the read command RDCM_D1<1PLANE> that is inputted for the fourth time are applied to a read operation of the memory device 150 in the order that they are inputted. Therefore, the first read command RDCM_D1<1PLANE> of the third read command group RD_GRP3 is the read command RDCM_D1<1PLANE> that is inputted for the second time at the moment T1, and the second read command RDCM_D1<1PLANE> of the third read command group RD_GRP3 is the read command RDCM_D1<1PLANE> that is inputted for the fourth time at the moment T1, and the third read command RDCM_D1<HALF> of the third read command group RD_GRP3 is the read command RDCM_D1<HALF> that is inputted for the third time at the moment T1.

As described above, after the third read command group RD_GRP3 is formed, the controller 130 may check out whether there is a second read command among the other read commands RDCM_D2<HALF>, RDCM_D2<HALF>, and RDCM_D3<HALF> which are not included in the third read command group RD_GRP3 subsequently, and if there is, the controller 130 may check out to which memory die among the memory dies 500, 510 and 520 the second read command corresponds. Herein, since the third read command group RD_GRP3 corresponds to the first memory die 500, if there is a second read command among the other read commands RDCM_D2<HALF>, RDCM_D2<HALF>, and RDCM_D3<HALF> which are not included in the third read command group RD_GRP3, the second read command may correspond to the second memory die 510 or the third memory die 520.

Likewise, the read commands RDCM_D2<HALF>, RDCM_D1<1PLANE>, RDCM_D1<HALF>, RDCM_D<1PLANE>, RDCM_D2<HALF>, and RDCM_D3<HALF> are checked out in the order that the read commands RDCM_D2<HALF>, RDCM_D<1PLANE>, RDCM_D1<HALF>, RDCM_D1<1PLANE>, RDCM_D2<HALF>, and RDCM_D3<HALF> are inputted to the command queue 650<T1> until the moment T1. Therefore, the controller 130 may search the other read commands RDCM_D2<HALF>, RDCM_D2<HALF>, and RDCM_D3<HALF> that are not included in the third read command group RD_GRP3 at the moment T1 for a read command that may be decided as a second read command, but the controller may not be able to decide that there is no such read command.

Therefore, the controller 130 may have to check out again whether at least two read commands that are decided as the third read commands correspond to the same one memory die and the same one plane among the other read commands RDCM_D2<HALF>, RDCM_D2<HALF>, and RDCM_D3<HALF> that are not included in the third read command group RD_GRP3 at the moment T1.

As it turns out that the read command RDCM_D2<HALF> that is inputted for the first time and the read command RDCM_D2<HALF> that is inputted for the fifth time are decided as the third read commands among the other read commands RDCM_D2<HALF>, RDCM_D2<HALF>, and RDCM_D3<HALF> that are not included in the third read command group RD_GRP3 at the moment T1, the controller 130 may be able to decide that the read command RDCM_D2<HALF> that is inputted for the first time and the read command RDCM_D2<HALF> that is inputted for the fifth time correspond to the second memory die 510 and the same one plane.

Therefore, the controller 130 may group the read command RDCM_D2<HALF> that is inputted for the first time and the read command RDCM_D2<HALF> that is inputted for the fifth time among the other read commands RDCM_D2<HALF>, RDCM_D2<HALF>, and RDCM_D3<HALF> that are not included in the third read command group RD_GRP3 at the moment T1 into a fourth read command group RD_GRP4.

Also, when the controller 130 forms the fourth read command group RD_GRP4, the controller 130 may adjust the order of the command queue 650 in such a manner that the read command RDCM_D2<HALF> that is inputted for the first time and the read command RDCM_D2<HALF> that is inputted for the fifth time may be applied to a read operation of the memory device 150 first in the inputted order.

Also, since the first read command RDCM_D1<1PLANE> among the read commands RDCM_D1<1PLANE>, RDCM_D1<HALF>, RDCM_D1<1PLANE> that are included in the third read command group RD_GRP3, which is formed earlier, is inputted from the host 102 posterior to the first read command RDCM_D2<HALF> of the fourth read command group RD_GRP4, which is formed later, the controller 130 may adjust the order of the command queue 650 in such a manner that the fourth read command group RD_GRP4 may be applied to a read operation of the memory device 150 prior to the third read command group RD_GRP3. Therefore, it may be seen that the read commands RDCM_D2<HALF> and RDCM_D2<HALF that are included in the fourth read command group RD_GRP4 at the moment T1 are stored at positions ahead of the positions of the read commands RDCM_D1<1PLANE>, RDCM_D1<HALF>, RDCM_D1<1PLANE>, and RDCM_D2<HALF> that are included in the third read command group RD_GRP3 in the command queue 650 at the moment T2 which comes later than the moment T1. In other words, the read commands RDCM_D2<HALF> and RDCM_D2<HALF that are included in the fourth read command group RD_GRP4 at the moment T1 are stored at the positions that may be applied to a read operation of the memory device 150 ahead of the positions of the read commands RDCM_D1<1PLANE>, RDCM_D1<HALF>, RDCM_D1<1PLANE>, and RDCM_D2<HALF> that are included in the third read command group RD_GRP3 in the command queue 650 at the moment T2 which comes later than the moment T1.

For the remaining read command RDCM_D3<HALF> that is not included in the first read command group RD_GRP1, the second read command group RD_GRP2, the third read command group RD_GRP3, and the fourth read command group RD_GRP4 at the moment T1, the controller 130 may decide it as a read command that may not be grouped into a read command group. Therefore, the controller 130 may not group the read command RDCM_D3<HALF> that is not included in the first read command group RD_GRP1, the second read command group RD_GRP2, the third read command group RD_GRP3, and the fourth read command group RD_GRP4 at the moment T1 and apply it to a read operation of the memory device 150 in the order it is inputted from the host 102. For this reason, it may be found out that the read command RDCM_D3<HALF> which is inputted for the sixth time at the moment T1 is not grouped into any read command group but stored in the command queue 650<T2> based on the inputted order.

Herein, the command queue 650<T1> and 650<T2> are stored in the memory unit 144 that is included in the controller 130. Herein, the reference symbol of the command queue 650<T1> at the moment T1 is differentiated from the command queue 650<T2> at the moment T2, which comes later than the moment T1, and actually, it may be assumed that one command queue 650 is stored in the memory unit 144.

To sum up, the controller 130 does not apply the read commands RDCM_D2<HALF>, RDCM_D1<1PLANE>, RDCM_D1<HALF>, RDCM_D1<1PLANE>, RDCM_D2<HALF>, and RDCM_D3<HALF> to a read operation of the memory device 150 in the order that the read commands RDCM_D2<HALF>, RDCM_D1<1PLANE>, RDCM_D1<HALF>, RDCM_D<1PLANE>, RDCM_D2<HALF>, and RDCM_D3<HALF> are inputted from the host 102, but the controller 130 may apply the read commands RDCM_D2<HALF>, RDCM_D1<1PLANE>, RDCM_D1<HALF>, RDCM_D1<1PLANE>, RDCM_D2<HALF>, and RDCM_D3<HALF> to a read operation of the memory device 150 by changing the order from a relatively big physical area unit to a relatively small physical area unit based on the physical address values of the read commands RDCM_D2<HALF>, RDCM_D1<1PLANE>, RDCM_D1<HALF>, RDCM_D1<1PLANE>, RDCM_D2<HALF>, and RDCM_D3<HALF>.

In this way, it is possible to minimize the number of times that a read operation is actually performed in the memory device 150. Since the principle that the number of times that a read operation is actually performed in the memory device 150 may be reduced or minimized is sufficiently described above with reference to FIG. 5, how the read commands RDCM_D2<HALF>, RDCM_D1<1PLANE>, RDCM_D1<HALF>, RDCM_D<1PLANE>, RDCM_D2<HALF>, and RDCM_D3<HALF> stored in the command queue 650<T2> at the moment T2 may be applied to a read operation of the memory device 150 is described.

To be specific, it is described, hereafter, that the read commands RDCM_D2<HALF>, RDCM_D1<1PLANE>, RDCM_D1<HALF>, RDCM_D1<1PLANE>, RDCM_D2<HALF>, and RDCM_D3<HALF> are grouped into the two read command groups RD_GRP3 and RD_GRP4 and each of the read command groups RD_GRP3 and RD_GRP4 is applied to a read operation of the memory device 150 in the state that the two read command groups RD_GRP3 and RD_GRP4 are stored in the command queue 650<T2> at the moment T2, which is the state that the order is changed from a relatively big physical area unit to a relatively small physical area unit based on the physical address values of the read commands RDCM_D2<HALF>, RDCM_D1<1PLANE>, RDCM_D1<HALF>, RDCM_D1<1PLANE>, RDCM_D2<HALF>, and RDCM_D3<HALF>.

First of all, as described above, it may be assumed that for each of the read commands RDCM_D2<HALF>, RDCM_D1<1PLANE>, RDCM_D1<HALF>, RDCM_D1<1PLANE>, RDCM_D2<HALF>, and RDCM_D3<HALF> that are stored in the command queue 650<T2> at the moment T2, the unit of a physical area that is read at once is different and the other lower physical address values are all the same.

In response to the first read command RDCM_D2<HALF> of the fourth read command group RD_GRP4, a half page is read at once by reading data from a half page of the 0^{th} page (not shown) of the first memory block BLOCK<30> in the first plane 511 among the two planes 511 and 512 that are included in the second memory die 510. Herein, the data of the half page that are read at once may be maintained to be stored in a page buffer (not shown) corresponding to the first plane 511 that is included in the second memory die 510.

In response to the second read command RDCM_D2<HALF> of the fourth read command group RD_GRP4, data of a half page may have to be read from the 0^{th} page (not shown) of the first memory block BLOCK<30> in the first plane 511 among the two planes 511 and 512 that are included in the second memory die 510. However, since the physical area unit of the first read command RDCM_D2<HALF> of the fourth read command group RD_GRP4 is the same as the physical area unit of the second read command RDCM_D2<HALF>, data of a half page may be read at once by re-using the half-page data that are stored in one page buffer (not shown) corresponding to the first plane 511 that is Included in the second memory die 510 according to the read operation based on the first read command RDCM_D2<HALF>. In other words, the half-page data that are stored in the 0^{th} page (not shown) of the first memory block BLOCK<30> of the first plane 511 that is included in the second memory die 510 may not be read again, but the half-page data that are stored in one page buffer (not shown) corresponding to the first plane 511 that is included in the second memory die 510 may be re-used.

In response to the first read command RDCM_D1<1PLANE> of the third read command group RD_GRP3, one page is read at once by reading data from the 0^{th} page (not shown) of the first memory block BLOCK<10> in the first plane 501 among the two planes 501 and 502 that are included in the first memory die 500. Herein, the data of one page that are read at once may be maintained to be stored in a page buffer (not shown) corresponding to the first plane 501 that is included in the first memory die 500.

In response to the second read command RDCM_D1<1PLANE> of the third read command group RD_GRP3, data of one page may have to be read from the 0^{th} page (not shown) of the first memory block BLOCK<10> in the first plane 501 among the two planes 501 and 502 that are included in the first memory die 500. However, since the physical area unit of the first read command RDCM_D1<1PLANE> of the third read command group RD_GRP3 is the same as the physical area unit of the second read command RDCM_D1<1PLANE>, data of one page may be read at once by re-using the one-page data that are stored in one page buffer (not shown) corresponding to the first plane 501 that is included in the first memory die 500 according to the read operation based on the first read command RDCM_D1<1PLANE>. In other words, the one-page data that are stored in the 0^{th} page (not shown) of the first memory block BLOCK<10> of the first plane 501 that is included in the first memory die 500 may not be read again, but the one-page data that are stored in one page buffer (not shown) corresponding to the first plane 501 that is included in the first memory die 500 may be re-used.

In response to the third read command RDCM_D1<HALF> of the third read command group RD_GRP3, data of a half page may have to be read from the 0^{th} page (not shown) of the first memory block BLOCK<10> in the first plane 501 among the two planes 501 and 502 that are Included in the first memory die 500. However, since the physical area unit of the first read command RDCM_D1<1PLANE> is greater than the physical area unit of the third read command RDCM_D1<HALF>, data of a half page may be read at once by re-using the half-page data that are stored in one page buffer (not shown) corresponding to the first plane 501 that is Included in the first memory die 500 according to the read operation based on the first read command RDCM_D1<1PLANE>. In other words, the half-page data that are stored in the 0^{th} page (not shown) of the first memory block BLOCK<10> of the first plane 501 that is included in the first memory die 500 may not be read again, but the half-page data that are stored in one page buffer (not shown) corresponding to the first plane 501 that is included in the first memory die 500 may be re-used.

As described above, when the read commands RDCM_D2<HALF>, RDCM_D1<1PLANE>, RDCM_D1<HALF>, RDCM_D1<1PLANE>, RDCM_D2<HALF>, and RDCM_D3<HALF> are applied to a read operation of the memory device 150 in the order of the read commands RDCM_D2<HALF>, RDCM_D2<HALF>, RDCM_D1<1PLANE>, RDCM_D1<HALF>, RDCM_D1<1PLANE>, and RDCM_D3<HALF> which is the order that they are stored in the command queue 650<T2> at the moment T2, the read operation may not be performed additionally.

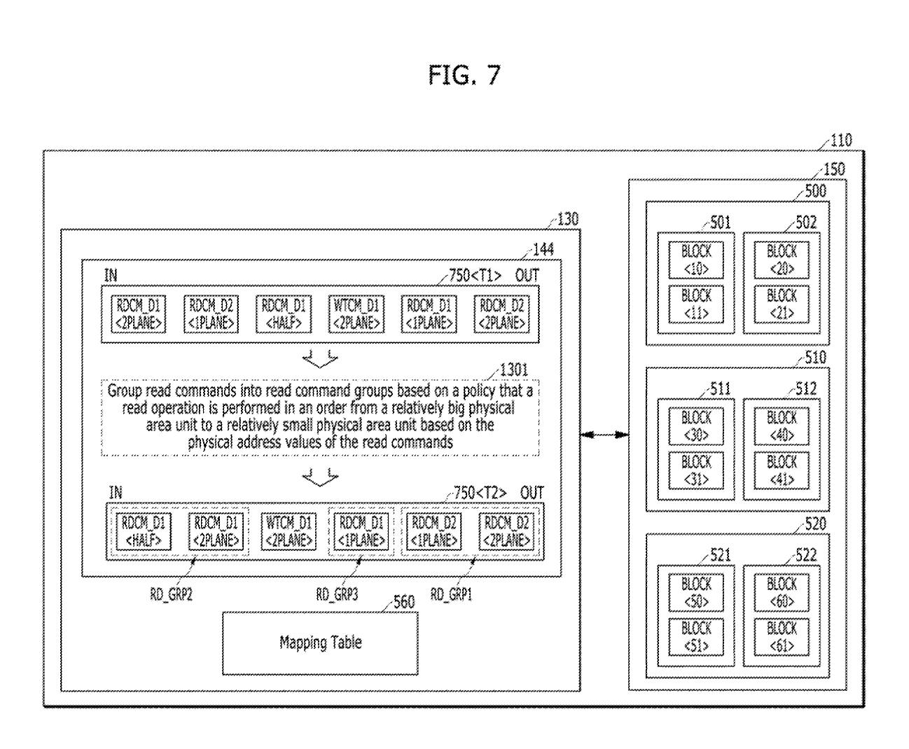

FIG. 7 shows another exemplary case of read commands RDCM_D2<2PLANE>, RDCM_D1<1PLANE>, RDCM_D1<HALF>, RDCM_D2<1PLANE>, and RDCM_D1<2PLANE> sequentially provided to the memory system 110 from the host 102 and queued in a command queue 650<T1> according to their Input order in the inside of the controller 130 at a moment T1.

Also, a write command WTCM_D1<2PLANE> is provided while providing the read commands. FIG. 7 exemplifies 5 read commands and one write command WTCM_D1<2PLANE> queued, wherein the write command WTCM_D1<2PLANE> is the third command in the command queue 650<T1>.

Referring to FIG. 7, the controller 130 may classify first and fourth read commands RDCM_D2<2PLANE> and RDCM D2<1PLANE> into the first priority group RD_GRP1. Also, the controller 130 may classify second and fifth read commands RDCM_D1<1PLANE> and RDCM_D1<2PLANE> into the second priority group RD GRP2. Further, the controller 130 may classify a third read command RDCM_D1<HALF> into the third priority group.

Referring to FIG. 7, the controller 130 may generate one or more read command groups for the respective target memory dies, i.e., the second and first memory dies 510 and 500 such that the read commands of the highest priority (e.g., the first and fifth read commands RDCM_D2<2PLANE> and RDCM_D1<2PLANE> of the first priority) are included in the first and second read command groups RD_GRP1 and RD_GRP2, respectively.

Further, the controller 130 may include the read commands of the lower priorities in the respective read command groups according to the target memory dies of the read commands such that read commands of the same target memory die are included in the same read command group.

Here, when the write command WTCM_D1<2PLANE> is queued amongst the read commands in the command queue 650<T1>, the controller 130 at a moment T2 may split the read command group of the same target memory die (e.g., the first memory die 500) as the write command WTCM_D1<2PLANE> since the write command WTCM_D1<2PLANE> may change data of a corresponding target memory die (e.g., the first memory die 500) and thus data read from the corresponding target memory die in response to a read command queued after the write command WTCM_D1<2PLANE> which has the same target memory die (e.g., the first memory die 500) as the write command WTCM_D1<2PLANE> may change due to the write command WTCM_D1<2PLANE>.

Referring to FIG. 7, at a moment T2, the controller 130 may generate the read command group RD_GRP1 including the read command of the highest priority, e.g., the first read command RDCM_D2<2PLANE> of the first priority for the target memory die, i.e., the second memory die 510. Further, the controller 130 may include in the read command group RD_GRP1 the fourth read command RDCM_D2<1PLANE> of the second priority which has the same target memory die (i.e., the second memory die 510) as the first read command RDCM_D2<2PLANE> of the highest priority (also referred to as the first priority) and also included in the read command group RD_GRP1.

FIG. 7 exemplifies the write command WTCM_D1<2PLANE> directed to the first memory die 500 as the target memory die. Therefore, the controller 130 may split the read command groups RD_GRP1 for the first memory die 500 as the target memory die, which is the same as the write command WTCM_D1<2PLANE>.

The controller 130 may split the read command group RD_GRP1 into two groups with reference to the single write command WTCM_D1<2PLANE>. One of the split read command groups may include read commands queued in the command queue 750<T1> prior to the write command WTCM_D1<2PLANE> and the other of the split read command groups may include read commands queued in the command queue 750<T1> after the write command WTCM_D1<2PLANE>.

FIG. 7 exemplifies the command queue 750<T1> in which the second read command RDCM_D1<1PLANE> is queued prior to the write command WTCM_D1<2PLANE> and the third and fifth read commands RDCM_D1<HALF> and RDCM_D1<2PLANE> are queued after the write command WTCM_D1<2PLANE>. Therefore, at a moment T2, the controller 130 may split the read command group for the first memory die 500 into second and third read command groups RD_GRP2 and RD_GRP3. The second read command group RD_GRP2 may exemplarily include one or more read commands queued in the command queue 750<T1> after the write command WTCM_D1<2PLANE>. The third read command group RD_GRP3 may exemplarily include one or more read commands queued in the command queue 750<T1> prior to the write command WTCM_D1<2PLANE>.

As exemplified in FIG. 7, the controller 130 may include in the third read command group RD_GRP3 the second read command RDCM_D1<1PLANE> queued in the command queue 750<T1> prior to the write command WTCM_D1<2PLANE>. Also, the controller 130 may include in the second read command group RD_GRP2 the third and fifth read commands RDCM_D1<HALF> and RDCM_D1<2PLANE> which were queued in the command queue 750<T1> after the write command WTCM_D1<2PLANE>.

In the respective read command groups RD_GRP1 to RD_GRP3, the order of execution of the read commands may depend on their priorities and input order of the read commands. A read command of a higher priority and earlier input order may be executed first in the respective read command groups RD_GRP1 to RD_GRP3, as described above with reference to FIGS. 5 and 6. For example, FIG. 7 illustrates the second read command group RD_GRP2 sequentially including the fifth and third read commands RDCM_D1<2PLANE> and RDCM_D1<HALF> according to their priority order.

In the command queue 750<T2> at the moment T2, the order of the commands may be the read commands of the first read command group RD_GRP1 directed to the second memory die 510, the read commands of the third read command group RD_GRP3 directed to the first memory die 500, the write command WTCM_D1<2PLANE> directed to the first memory die 500 and then the read commands of the second read command group RD_GRP2 directed to the first memory die 500.

Therefore, in a similar way to the embodiments described with reference to FIGS. 5 and 6, when read and write operations are performed to the memory device 150 in response to the ordered read and write commands in the command queue 750<T2> at the moment T2, an additional read operation may be prevented.

Therefore, the number of read operation times actually performed to the memory device 150 may be reduced or minimized.

As described above, with reference to FIG. 7, a starting point of the read operation in the respective memory blocks of the memory device 150 may be predetermined, which is the same as the embodiments described with reference to FIGS. 5 and 6.

FIG. 7 illustrates a case wherein in the commands which are inputted from the host 102, there is a write command WTCM_D1<2PLANE> being mixed with the read commands RDCM_D2<2PLANE>, RDCM_D1<1PLANE>, RDCM_D1<HALF>, RDCM_D2<1PLANE>, and RDCM_D1<2PLANE>. In this case, the controller 130 may perform a grouping operation for forming read command groups onto the read commands RDCM_D2<2PLANE>, RDCM_D1<1PLANE>, RDCM_D1<HALF>, RDCM_D2<1PLANE>, and RDCM_D1<2PLANE> inputted from the host 102 only. Also, when there are first read commands, second read commands, and third read commands on both sides of the write command WTCM_D1<2PLANE>, the controller 130 may separately group the first read commands, the second read commands, and third read commands on both sides of the write command WTCM_D1<2PLANE> into different read command groups. In other words, the case where there are the first read commands, the second read commands, and the third read commands on both sides of the write command WTCM_D1<2PLANE> is a case that when it is assumed that there is no write command WTCM_D1<2PLANE>, the read commands may have to be grouped into a first read command group RD_GRP1 or a second read command group RD_GRP2. However, since there is the write command WTCM_D1<2PLANE>, a total of two read command groups, which include a first read command group RD_GRP1 and a second read command group RD_GRP, one read command group on each side based on the write command WTCM_D1<2PLANE>, may be generated.

Also, when there is no read command that is decided as a first read command and there are a second read command and a third read command on both sides of the write command WTCM_D1<2PLANE>, the controller 130 may separately group the second read command and the third read command existing on both sides of the write command WTCM_D1<2PLANE> into different read command groups. In other words, a case where there is no first read command and there are a second read command and a third read command on both sides of the write command WTCM_D1<2PLANE> may be a case that the read commands are grouped into one third read command group RD_GRP3 if there is no write command WTCM_D1<2PLANE>. However, since there is the write command WTCM_D1<2PLANE>, a total of two third read command groups, one read command group on each side based on the write command WTCM_D1<2PLANE>, may be generated.

Also, when there are no read commands which are determined as a first read command and a second read command based on both sides of the write command WTCM_D1<2PLANE> and there are at least two or more third read commands corresponding to the same memory die and the same plane, the controller 130 may separately group the two or more third read commands corresponding to the same memory die and the same plane that exist on both sides of the write command WTCM_D1<2PLANE> into different read command groups. In short, the case where there is no read commands that are decided as a first read command and a second read command based on both sides of the write command WTCM_D1<2PLANE> and there are at least two or more third read commands corresponding to the same memory die and the same plane is a case that the read commands may have to be grouped into a fourth read command group RD_GRP4 if there is no write command WTCM_D1<2PLANE>. However, since there is the write command WTCM_D1<2PLANE>, a total of two fourth read command groups RD_GRP4 may be generated on both sides of the write command WTCM_D1<2PLANE>, one on each side.

Hence, if there is the write command WTCM_D1<2PLANE> mixed with the read commands RDCM_D2<2PLANE>, RDCM_D1<1PLANE>, RDCM_D1<HALF>, RDCM_D2<1PLANE>, and RDCM_D1<2PLANE> inputted from the host 102, a read command grouping operation may be performed separately based on the write command WTCM_D1<2PLANE>.

More specifically, the five read commands RDCM_D2<2PLANE>, RDCM_D1<1PLANE>, RDCM_D1<HALF>, RDCM_D2<1PLANE>, and RDCM_D1<2PLANE> which are inputted from the host 102 may be grouped as follows.

First, it may be seen that the write command WTCM_D1<2PLANE> is inputted between the read command RDCM_D1<1PLANE> that is inputted for the second time and the read command RDCM_D1<HALF> that is inputted for the third time among the five read commands RDCM_D2<2PLANE>, RDCM_D1<1PLANE>, RDCM_D1<HALF>, RDCM_D2<1PLANE>, and RDCM_D1<2PLANE> Inputted from the host 102.

Herein, to have a look at the physical address value of the write command WTCM_D1<2PLANE>, the write command WTCM_D1<2PLANE> may correspond to the planes 501 and 502 that are included in the first memory die 500. Therefore, the read command RDCM_D1<1PLANE> that is inputted ahead of the write command WTCM_D1<2PLANE> and corresponds to the first memory die 500 and the read commands RDCM_D1<HALF> and RDCM_D1<2PLANE> that are inputted behind the write command WTCM_D1<2PLANE> and also correspond to the first memory die 500 may become the subjects for separate read command grouping operations. Conversely, the read commands RDCM_D2<2PLANE> and RDCM_D2<1PLANE> that are inputted ahead of the write command WTCM_D1<2PLANE> and correspond to the second memory die 510 or the third memory die 520 may not be the subject for a separate read command grouping operation.

Therefore, the controller 130 may rearrange the read commands RDCM_D2<2PLANE>, RDCM_D1<1PLANE>, RDCM_D1<HALF>, RDCM_D2<1PLANE>, and RDCM_D1<2PLANE> that are stored in a command queue 750<T1> at the moment T1 into the order at the moment T2 through the read command grouping operation 1301, which is described above with reference to FIGS. 5 and 6. The read command grouping operation 1301 may be performed between the moment T1 and the moment T2 in FIG. 7 in a separated form due to the presence of the write command WTCM_D1<2PLANE>.

To be specific, there are six commands RDCM_D2<2PLANE>, RDCM_D1<1PLANE>, RDCM_D1<HALF>, WTCM_D1<2PLANE>, RDCM_D2<1PLANE>, and RDCM_D1<2PLANE> stored in the command queue 750<T1> at the moment T1 of FIG. 7. Among them are five read commands RDCM_D2<2PLANE>, RDCM_D1<1PLANE>, RDCM_D1<HALF>, RDCM_D2<1PLANE>, and RDCM_D1<2PLANE> and one write command WTCM_D1<2PLANE>. Also, the write command WTCM_D1<2PLANE> may correspond to the first memory die 500 and may be a command that is inputted third. Therefore, the controller 130 may separate the read command corresponding to the first memory die 500 and inputted before the input of the write command WTCM_D1<2PLANE>, which is the read command RDCM_D1<1PLANE> inputted second, from the read commands corresponding to the first memory die 500 and inputted after the input of the write command WTCM_D1<2PLANE>, which is the read command RDCM_D1<HALF> inputted fourth, and the read command RDCM_D1<2PLANE> inputted sixth, and apply the read commands separately to a read command grouping operation. Also, the controller 130 may collectively apply the read commands corresponding to the second memory die 510 or the third memory die 520, which are the read command RDCM_D2<2PLANE> that is inputted first and the read command RDCM_D2<1PLANE> that is inputted fifth, to a read command grouping operation, regardless of the presence of the write command WTCM_D1<2PLANE>.

Therefore, it may be seen that a read command group is formed based on the write command WTCM_D1<2PLANE> in a command queue 750<T2> at the moment T2 of FIG. 7.

To be specific, the read commands corresponding to the second memory die 510 that are inputted first at the moment T1, too, which include the read command RDCM_D2<2PLANE> that is inputted first and the read command RDCM_D2<1PLANE> that is inputted fifth, may be grouped into a first read command group RD_GRP1 in a command queue 750<T2> at the moment T2 of FIG. 7, with no regard to the write command WTCM_D1<2PLANE>. Subsequently, the read command corresponding to the first memory die 500 that is inputted before the input of the write command WTCM_D1<2PLANE> at the moment T1 and affected by the write command WTCM_D1<2PLANE>, which is the read command RDCM_D1<1PLANE> inputted second at the moment T1, is grouped into a third read command group RD_GRP3. Subsequently, the read commands corresponding to the first memory die 500 that are inputted after the input of the write command WTCM_D1<2PLANE> at the moment T1 and affected by the write command WTCM_D1<2PLANE>, which include the read command RDCM_D1<HALF> inputted fourth and the read command RDCM_D1<2PLANE> inputted for sixth at the moment T1, are grouped into a second read command group RD_GRP2.

As shown in the embodiment of FIG. 7, when the read commands RDCM_D2<2PLANE>, RDCM_D1<1PLANE>, RDCM_D1<HALF>, WTCM_D1<2PLANE>, RDCM_D2<1PLANE>, and RDCM_D1<2PLANE> that are stored in the command queue 750<T2> at the moment T2 are arranged in the order of the command queue 750<T2> at the moment T2 and applied to a read operation of the memory device 150, it is possible to minimize the number of times that a read operation is additionally performed, even though a write operation is performed between read operations.

Therefore, it is possible to minimize the number of times that a read operation is actually performed in the memory device 150.

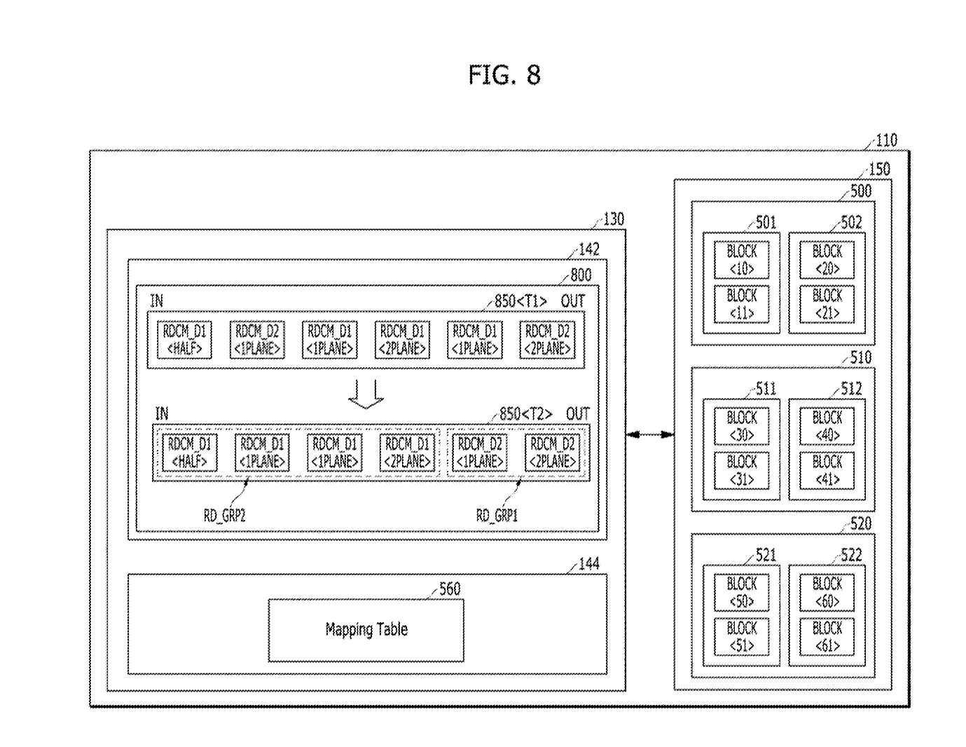

FIG. 8 is a block diagram illustrating a memory system in accordance with another embodiment of the present invention.

Referring to FIG. 8, the memory system 110 may include a controller 130, a memory device 150, a memory unit 144 and a NAND flash controller unit (NFC) 142 as in FIG. 1. The memory device 150 may include a plurality of memory dies 500, 510 and 520, and each of the memory dies 500, 510 and 520 may include a plurality of planes 501 and 502, 511 and 512, and 521 and 522, respectively. Each of the planes 501 and 502, 511 and 512, and 521 and 522 may include a plurality of memory blocks BLOCK<10, 11> and BLOCK<20, 21>, BLOCK<30, 31> and BLOCK<40, 41>, and BLOCK<50, 51> and BLOCK<60, 61>. Each of the memory blocks BLOCK<10, 11> and BLOCK<20, 21>, BLOCK<30, 31> and BLOCK<40, 41>, and BLOCK<50, 51> and BLOCK<60, 61> may include a plurality of pages (not shown).

Herein, FIG. 8 shows one memory device 150 being included in the memory system 110. However, this is only one embodiment and more memory devices 150 may be included in the memory system 110. Also, FIG. 8 shows the memory device 150 including three memory dies 500, 510 and 520, however, more memory dies may be included in the memory device 150. Also, FIG. 8 shows that each of the memory dies 500, 510 and 520 includes two planes 501 and 502, 511 and 512, or 521 and 522, however, more planes may be included in each of the memory dies 500, 510 and 520. Also, each of the planes 501 and 502, 511 and 512, and 521 and 522 is illustrated to include two memory blocks BLOCK<10, 11> and BLOCK<20, 21>, BLOCK<30, 31> and BLOCK<40, 41>, or BLOCK<50, 51> and BLOCK<60, 61>. This is also not more than one embodiment and actually, more memory blocks may be included in each of the planes 501 and 502, 511 and 512, and 521 and 522. Also, it is illustrated in FIG. 8 that a host interface (I/F) unit 132, a processing unit 134, an Error Correction Code (ECC) unit 138, and a power management unit 140 are not included in the controller 130, whereas the host interface unit 132, the processing unit 134, the ECC unit 138, and the power management unit 140 are illustrated to be included in the controller 130 in FIG. 1. However, this is for the sake of convenience in description, and actually, the host Interface unit 132, the processing unit 134, the ECC unit 138, and the power management unit 140 of FIG. 8 may be included in the controller 130.

The internal structure of the controller 130 of the memory system 110 of FIG. 8 differs from the internal structure of the controller of the memory system 110 in accordance with the embodiment of the present invention shown in FIGS. 5 to 7.

To be specific, the command queues 550<T1> and 550<T2>, 650<T1> and 650<T2>, and 750<T1> and 750<T2> that are described to be stored in the memory unit 144 in FIGS. 5 to 7 are described to be stored in command queues 850<T1> and 850<T2> inside the NAND flash controller unit 142.

This structural difference signifies the following.

First, in the embodiment of FIGS. 5-7, the command queues 550<T1> and 550<T2>, 650<T1> and 650<T2>, and 750<T1> and 750<T2> are stored in the memory unit 144 and the operation 1301 of the controller 130 for grouping the read commands into at least one or more read command groups based on the policy that a read operation of the memory device 150 is performed from a relatively big physical area unit to a relatively small physical area unit based on the physical address of each of the read commands, is performed in the processing unit 134 shown in FIG. 1.

However, in the embodiment of FIG. 8, the command queues 850<T1> and 850<T2> are stored in the NAND flash controller unit 142 in FIG. 8 meaning that the NAND flash controller unit 142 receives the read commands from the processing unit 134, stores them in the command queues 850<T1> and 850<T2> inside, and then performs the operation of the controller 130 described above, which is the operation 1301 of grouping the read commands into at least one or more read command groups based on the policy that a read operation of the memory device 150 is performed from a relatively big physical area unit to a relatively small physical area unit based on the physical address value of each of the read commands. Herein, the NAND flash controller unit 142 may include a register (or a memory) for storing the command queues 850<T1> and 850<T2>, which is not described in FIG. 1.

The structure of the memory system in accordance with the embodiment of the present invention illustrated in FIG. 8 is described further in more detail below.

First, the NAND flash controller unit 142 shown in FIG. 8 may include a read operation controller 800 and the read operation controller 800 may include command queues 850<T1> and 850<T2>.

The read operation controller 800 is illustrated to be separately included in the NAND flash controller unit 142 in the drawing to separately describe the operation of the NAND flash controller unit 142 (which is described above with reference to FIG. 1), which includes generating a control signal of the memory device 150 and processing data under the control of the processing unit 134, from the above-described operation, which is the operation 1301 of grouping the read commands into at least one or more read command groups based on the policy that is designed in such a manner that a read operation of the memory device 150 is performed from a relatively big physical area unit to a relatively small physical area unit based on the physical address value of each of the read commands. In short, the read operation controller 800 illustrated in FIG. 8 may not be a constituent element that can be detected physically, but may be a logical constituent element separately describing a portion of the operation of the NAND flash controller unit 142.

Since the command queues 850<T1> and 850<T2> are included in the inside of the NAND flash controller unit 142 in the embodiment of FIG. 8, the memory unit 144 may include the mapping table 560 alone.

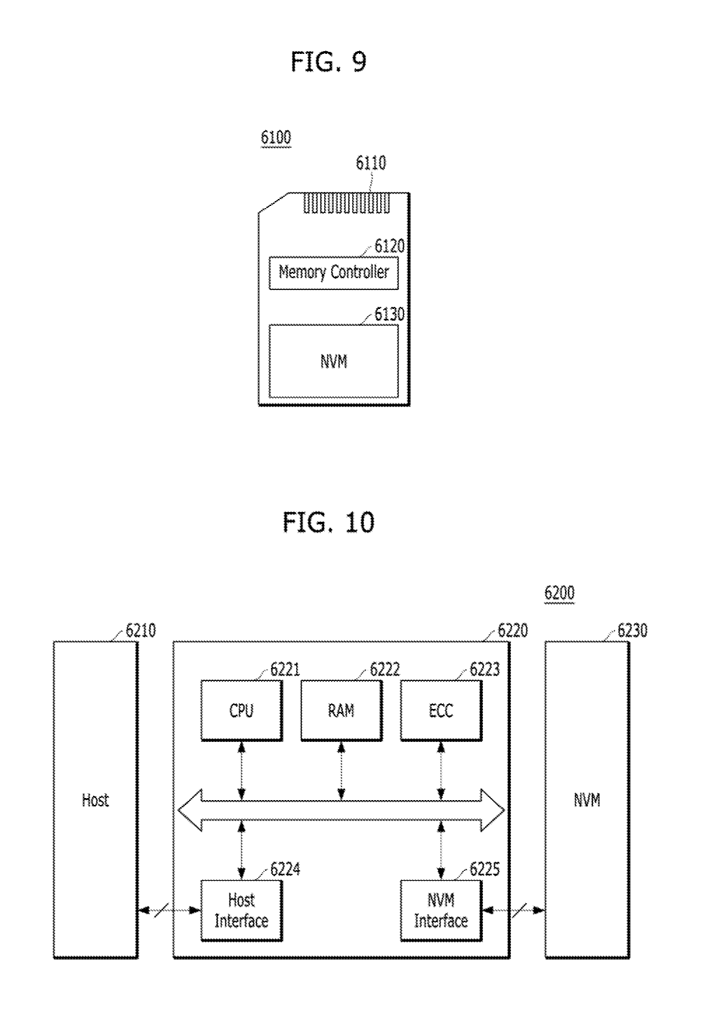

Also, it may be seen that the operation characteristic to the present invention which is exemplarily described as the operation of the NAND flash controller unit 142 in FIG. 8, which is the operation 1301 of grouping the read commands into at least one or more read command groups so that a read operation of the memory device 150 is performed from a relatively big physical area unit to a relatively small physical area unit based on the physical address value of each of the read commands, is the same as the operation described in reference to FIG. 5, and therefore, further description thereof is not provided herein. FIGS. 9 to 17 are diagrams schematically illustrating application examples of the data processing system of FIG. 1.

FIG. 9 is a diagram schematically Illustrating another example of the data processing system 100. FIG. 9 schematically illustrates a memory card system to which the memory system in accordance with the present embodiment is applied.

Referring to FIG. 9, the memory card system 6100 may include a memory controller 6120, a memory device 6130 and a connector 6110.

More specifically, the memory controller 6120 may be connected to the memory device 6130 embodied by a nonvolatile memory, and configured to access the memory device 6130. For example, the memory controller 6120 may be configured to control read, write, erase and background operations of the memory device 6130. The memory controller 6120 may be configured to provide an interface between the memory device 6130 and a host, and drive firmware for controlling the memory device 6130. That is, the memory controller 6120 may correspond to the controller 130 of the memory system 110 described with reference to FIGS. 1 and 5, and the memory device 6130 may correspond to the memory device 150 of the memory system 110 described with reference to FIGS. 1 and 5.

Thus, the memory controller 6120 may include a RAM, a processing unit, a host interface, a memory interface and an error correction unit. The memory controller 130 may further include the elements shown in FIG. 5.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (STT-RAM). The memory device 6130 may include a plurality of dies as in the memory device 150 of FIG. 5.

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g., SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 10 is a diagram schematically illustrating another example of the data processing system including the memory system in accordance with an embodiment.

Referring to FIG. 10, the data processing system 6200 may include a memory device 6230 having one or more nonvolatile memories and a memory controller 6220 for controlling the memory device 6230. The data processing system 6200 illustrated in FIG. 10 may serve as a storage medium such as a memory card (CF, SD, micro-SD or the like) or USB device, as described with reference to FIG. 1. The memory device 6230 may correspond to the memory device 150 in the memory system 110 illustrated in FIGS. 1 and 5, and the memory controller 6220 may correspond to the controller 130 in the memory system 110 illustrated in FIGS. 1 and 5.

The memory controller 6220 may control a read, write or erase operation on the memory device 6230 in response to a request of the host 6210, and the memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221, and used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224, and transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WIFI or Long Term Evolution (LTE). The memory controller 6220 may be connected to an external device, for example, the host 6210 or another external device, and then transmit/receive data to/from the external device. In particular, as the memory controller 6220 is configured to communicate with the external device through one or more of various communication protocols, the memory system and the data processing system in accordance with the present embodiment may be applied to wired/wireless electronic devices or particularly a mobile electronic device.

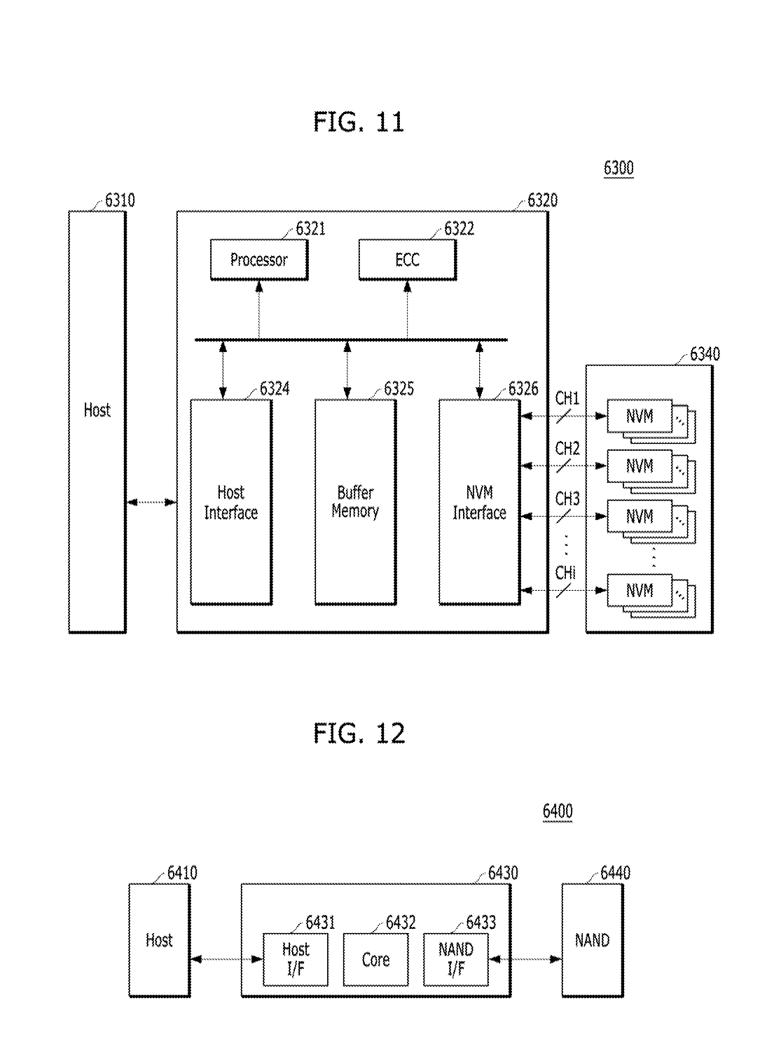

FIG. 11 is a diagram schematically illustrating another example of the data processing system including the memory system in accordance with an embodiment. FIG. 12 schematically illustrates an SSD including the memory system 110.

Referring to FIG. 11, the SSD 6300 may include a controller 6320 and a memory device 6340 including a plurality of nonvolatile memories. The controller 6320 may correspond to the controller 130 in the memory system 110 of FIGS. 1 and 5, and the memory device 6340 may correspond to the memory device 150 in the memory system of FIGS. 1 and 5.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. For convenience of description, FIG. 10 illustrates that the buffer memory 6325 exists in the controller 6320. However, the buffer memory 6325 may exist outside the controller 6320.

The ECC circuit 6322 may calculate an ECC value of data to be programmed to the memory device 6340 during a program operation, perform an error correction operation on data read from the memory device 6340 based on the ECC value during a read operation, and perform an error correction operation on data recovered from the memory device 6340 during a failed data recovery operation.

The host interface 6324 may provide an interface function with an external device, for example, the host 6310, and the nonvolatile memory interface 6326 may provide an interface function with the memory device 6340 connected through the plurality of channels.

Furthermore, a plurality of SSDs 6300 to which the memory system 110 of FIGS. 1 and 5 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300, and output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300, and provide data read from the selected SSDs 6300 to the host 6310.

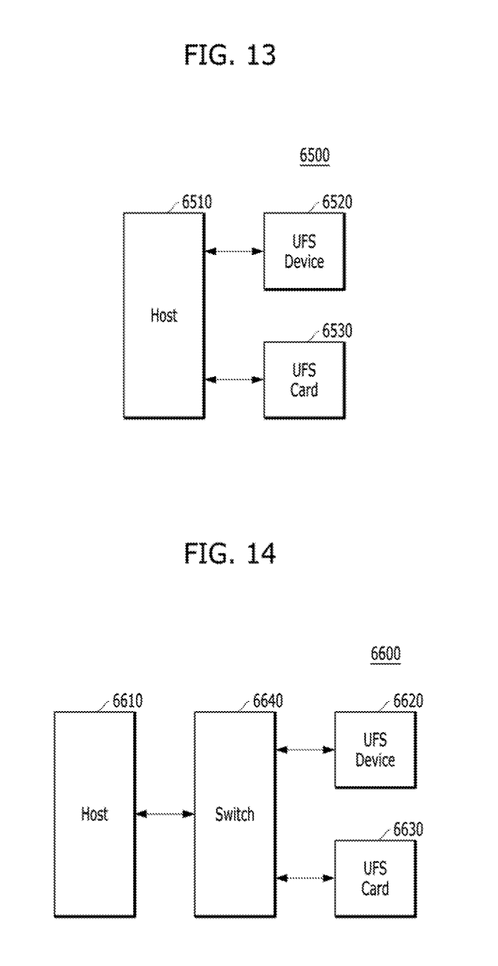

FIG. 12 is a diagram schematically illustrating another example of the data processing system including the memory system in accordance with an embodiment. FIG. 13 schematically illustrates an embedded Multi-Media Card (eMMC) including the memory system 110.

Referring to FIG. 12, the eMMC 6400 may include a controller 6430 and a memory device 6440 embodied by one or more NAND flash memories. The controller 6430 may correspond to the controller 130 in the memory system 110 of FIGS. 1 and 5, and the memory device 6440 may correspond to the memory device 150 in the memory system 110 of FIGS. 1 and 5.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400, the host interface 6431 may provide an interface function between the controller 6430 and the host 6410, and the NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) Interface.

FIGS. 13 to 16 are diagrams schematically illustrating other examples of the data processing system including the memory system in accordance with an embodiment. Specifically, FIGS. 14 to 17 schematically illustrate Universal Flash Storage (UFS) systems including the memory system 110.

Referring to FIGS. 13 to 16, the UFS systems 6500, 6600, 6700 and 6800 may include hosts 6510, 6610, 6710 and 6810, UFS devices 6520, 6620, 6720 and 6820 and UFS cards 6530, 6630, 6730 and 6830, respectively. The hosts 6510, 6610, 6710 and 6810 may serve as application processors of wired/wireless electronic devices or particularly mobile electronic devices, the UFS devices 6520, 6620, 6720 and 6820 may serve as embedded UFS devices, and the UFS cards 6530, 6630, 6730 and 6830 may serve as external embedded UFS devices or removable UFS cards.

The hosts 6510, 6610, 6710 and 6810, the UFS devices 6520, 6620, 6720 and 6820 and the UFS cards 6530, 6630, 6730 and 6830 in the respective UFS systems 6500, 6600, 6700 and 6800 may communicate with external devices, for example, wired/wireless electronic devices or particularly mobile electronic devices through UFS protocols, and the UFS devices 6520, 6620, 6720 and 6820 and the UFS cards 6530, 6630, 6730 and 6830 may be embodied by the memory system 110 illustrated in FIGS. 1 and 5. For example, in the UFS systems 6500, 6600, 6700 and 6800, the UFS devices 6520, 6620, 6720 and 6820 may be embodied in the form of the data processing system 6200, the SSD 6300 or the eMMC 6400 described with reference to FIGS. 10 to 12, and the UFS cards 6530, 6630, 6730 and 6830 may be embodied in the form of the memory card system 6100 described with reference to FIG. 9.

Furthermore, in the UFS systems 6500, 6600, 6700 and 6800, the hosts 6510, 6610, 6710 and 6810, the UFS devices 6520, 6620, 6720 and 6820 and the UFS cards 6530, 6630, 6730 and 6830 may communicate with each other through an UFS interface, for example, MIPI M-PHY and MIPI Unified Protocol (UniPro) in Mobile Industry Processor Interface (MIPI). Furthermore, the UFS devices 6520, 6620, 6720 and 6820 and the UFS cards 6530, 6630, 6730 and 6830 may communicate with each other through various protocols other than the UFS protocol, for example, UFDs, MMC, SD, mini-SD, and micro-SD.

In the UFS system 6500 illustrated in FIG. 13, each of the host 6510, the UFS device 6520 and the UFS card 6530 may include UniPro. The host 6510 may perform a switching operation in order to communicate with the UFS device 6520 and the UFS card 6530. In particular, the host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410, and a plurality of UFS cards may be connected in parallel or in the form of a star to the UFS device 6520 or connected in series or in the form of a chain to the UFS device 6520.

In the UFS system 6600 illustrated in FIG. 14, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640, and a plurality of UFS cards may be connected in series or in the form of a chain to the UFS device 6620.

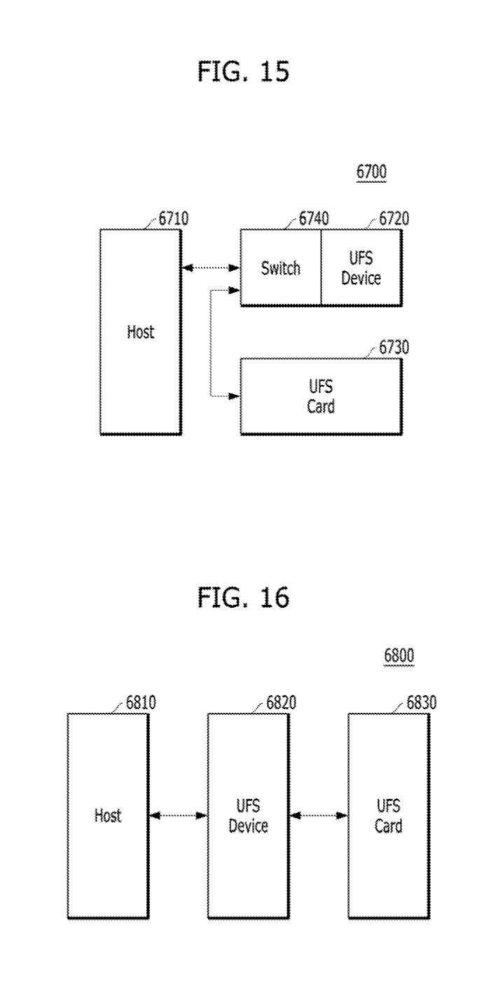

In the UFS system 6700 illustrated in FIG. 15, each of the host 6710, the UFS device 6720 and the UFS card 6730 may include UniPro, and the host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules each including the switching module 6740 and the UFS device 6720 may be connected in parallel or in the form of a star to the host 6710 or connected in series or in the form of a chain to each other. Furthermore, a plurality of UFS cards may be connected in parallel or in the form of a star to the UFS device 6720.

In the UFS system 6800 illustrated in FIG. 16, each of the host 6810, the UFS device 6820 and the UFS card 6830 may include M-PHY and UniPro. The UFS device 6820 may perform a switching operation in order to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, for example, through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810, or connected in series or in the form of a chain to the host 6810, and a plurality of UFS cards may be connected in parallel or in the form of a star to the UFS device 6820, or connected in series or in the form of a chain to the UFS device 6820.

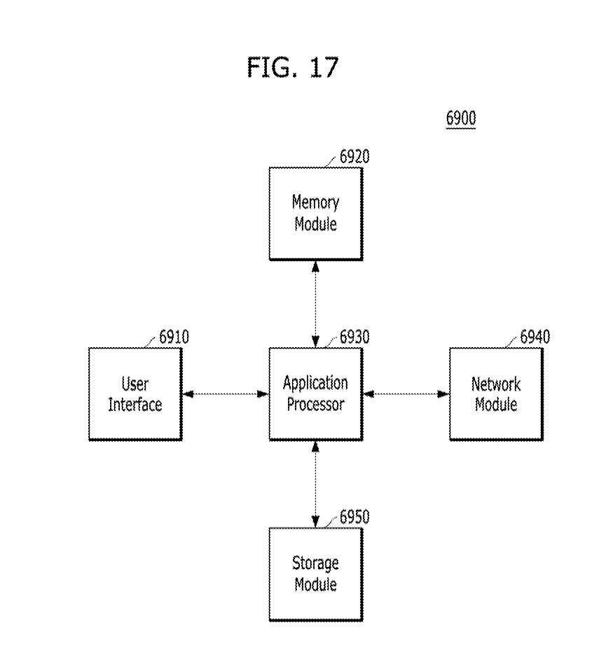

FIG. 17 is a diagram schematically illustrating another example of the data processing system including a memory system in accordance with an embodiment. FIG. 18 is a diagram schematically illustrating a user system including the memory system 110.

Referring to FIG. 17, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, Interfaces and a graphic engine which control the components included in the user system 6900. The application processor 6930 may be provided as System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. For example, the application processor 6930 and the memory module 6920 may be packaged and mounted, based on POP (Package on Package).

The network module 6940 may communicate with external devices. For example, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930, and then may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, NOR flash and 3D NAND flash, and provided as a removable storage medium such as a memory card or external drive of the user system 6900. The storage module 6950 may correspond to the memory system 110 described with reference to FIGS. 1 and 5. Furthermore, the storage module 6950 may be embodied as an SSD, eMMC and UFS as described above with reference to FIGS. 11 to 16.

The user Interface 6910 may include interfaces for inputting data or commands to the application processor 6930 or outputting data to an external device. For example, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIGS. 1 and 5 is applied to a mobile electronic device of the user system 6900, the application processor 6930 may control overall operations of the mobile electronic device, and the network module 6940 may serve as a communication module for controlling wired/wireless communication with an external device. The user Interface 6910 may display data processed by the processor 6930 on a display/touch module of the mobile electronic device, or support a function of receiving data from the touch panel.

According to the embodiment of the present invention, the read commands requested from the host may be grouped based on a predetermined policy in such a manner that a read operation may be performed in an order from relatively big physical areas to relatively smaller physical areas, and then the read command may be performed on a group basis.

In this way, it is possible to minimize the repeated performance of a read operation from the memory device.

While the present invention has been described with respect to specific embodiments, it will be apparent to those skilled in the art that various changes and modifications may be made without departing from the spirit and scope of the invention as defined in the following claims.

What is claimed is:

1. A memory system comprising:
a memory device including a plurality of memory dies; and
a controller suitable for grouping a plurality of read commands into one or more read command groups according to the memory dies as target memory dies of the read commands, arranging in the respective read command groups the read commands according to sizes of read area of the read commands in the respective target memory dies, and controlling the memory device to perform read operations in response to the grouped and arranged read commands,
wherein the controller arranges the read commands based on physical addresses of the target memory die identified from the read commands, and
wherein starting points of the read operations to the memory device in response to the read commands are predetermined.

2. The memory system of claim 1, wherein the controller arranges the read commands included in the respective read command groups in descending order of the sizes of read area of the read commands.

3. The memory system of claim 2,
wherein the controller further arranges the read commands included in the respective read command groups in an input order of the read commands, which have the same size of read area as one another, and
wherein the input order of the read commands is an order of the read commands input to the memory system.

4. The memory system of claim 1, wherein the controller groups the read commands such that read commands directed to the same target memory die as one another are included in one of the read command groups.

5. The memory system of claim 4,
wherein the controller further arranges the read command groups according to an input order of the read commands, which respectively have greatest sizes of read area in the respective read command groups, and
wherein the input order of the read commands is an order of the read commands input to the memory system.

6. The memory system of claim 3,
wherein when a write command is provided amongst the read commands to the memory system, the controller further split a read command group, which is directed to the same target memory die as the write command among the read command groups, into two sub read command groups,
wherein, between the split two sub read command groups, a first sub read command group includes one or more read commands, which are provided to the memory system prior to the write command, and
wherein, between the split two sub read command groups, a second sub read command group includes one or more read commands, which are provided to the memory system after the write command.

7. The memory system of claim 1,
further comprising a mapping table storing mapping relation between a logical address and a physical address of the memory dies, and
wherein the controller further identifies the physical addresses of the target memory die from logical addresses provided with the read commands through the mapping table.

8. A method for operating a memory system including a memory device having a plurality of memory dies, the method comprising:
grouping a plurality of read commands into one or more read command groups according to the memory dies as target memory dies of the read commands;
arranging in the respective read command groups the read commands according to sizes of read area of the read commands in the respective target memory dies; and
controlling the memory device to perform read operations in response to the grouped and arranged read commands,
wherein the read commands are arranged on a basis of physical addresses of the target memory die identified from the read commands, and
wherein starting points of the read operations to the memory device in response to the read commands are predetermined.

9. The method of claim 8, wherein the read commands are arranged in the respective read command groups in descending order of the sizes of read area of the read commands.

10. The method of claim 9,
further comprising arranging the read commands included in the respective read command groups in an input order of the read commands, which have the same size of read area as one another, and
wherein the input order of the read commands is an order of the read commands input to the memory system.

11. The memory system of claim 8, wherein the grouping of the read commands is performed such that read commands directed to the same target memory die as one another are included in one of the read command groups.

12. The method of claim 11,
further comprising arranging the read command groups according to an input order of the read commands, which respectively have greatest sizes of read area in the respective read command groups,
wherein the input order of the read commands is an order of the read commands input to the memory system.

13. The method of claim 10,
further comprising, when a write command is provided amongst the read commands to the memory system, splitting a read command group, which is directed to the same target memory die as the write command among the read command groups, into two sub read command groups,
wherein, between the split two sub read command groups, a first sub read command group includes one or more read commands, which are provided to the memory system prior to the write command, and
wherein, between the split two sub read command groups, a second sub read command group includes one or more read commands, which are provided to the memory system after the write command.

14. The method of claim 8,
further comprising identifying the physical addresses of the target memory die from logical addresses provided with the read commands through a mapping table storing mapping relation between a logical address and a physical address of the memory dies.
